(19) United States
(12) Patent Application Publication
(10) Pub. No.: US 2025/0317938 A1
(43) Pub. Date: Oct. 9, 2025

(54) DMRS ENHANCEMENT

(71) Applicant: InterDigital Patent Holdings, Inc., Wilmington, DE (US)

(72) Inventors: Afshin Haghighat, Ile-Bizard (CA); Toluwanimi Fagorusi, Montreal (CA); Loic Canonne-Velasquez, Dorval (CA); Jonghyun Park, Syosset, NY (US); Moon-il Lee, Melville, NY (US); Dylan Watts, Montreal (CA)

(73) Assignee: InterDigital Patent Holdings, Inc., Wilmington, DE (US)

(21) Appl. No.: 18/860,559

(22) PCT Filed: Apr. 27, 2023
(86) PCT No.: PCT/US2023/020194

§ 371 Date: Oct. 25, 2024

Related U.S. Application Data
(60) Provisional application No. 63/335,504, filed on Apr. 27, 2022.
(60) Provisional application No. 63/395,457, filed on Aug. 5, 2022.
(60) Provisional application No. 63/411,355, filed on Sep. 29, 2022.
(60) Provisional application No. 63/422,069, filed on Nov. 3, 2022.
(60) Provisional application No. 63/445,342, filed on Feb. 14, 2023.

(51) Int. Cl. H04W 72/231; H04L 1/00; H04L 5/00; H04W 72/51

(52) U.S. Cl. CPC H04W 72/231; H04L 1/0003; H04L 5/0044; H04L 5/0051; H04W 72/51

(57) ABSTRACT

A WTRU may receive DCI comprising information scheduling a transmission and associating DMRS ports with COM groups. The WTRU, based on the DCI, may associate a first DMRS port with a first CDM group and associate a second DMRS port with a second CDM group. The WTRU may map the first DMRS port associated with the first CDM group to a first antenna group and may map the second DMRS port associated with the second CDM group to a second antenna group. The WTRU may transmit at least a first DMRS using the first DMRS port and the first antenna group and may transmit at least a second DMRS using the second DMRS port and the second antenna group. The WTRU may select, based on an MCS, the first DMRS port, associate a first PTRS port with the first DMRS port, and transmit a PTRS using the PTRS port.

### CROSS-REFERENCE TO RELATED APPLICATIONS

This application claims the benefit of Provisional U.S. Patent Application No. 63/335,504, filed Apr. 27, 2022, Provisional U.S. Patent Application No. 63/395,457, filed Aug. 5, 2022, Provisional U.S. Patent Application No. 63/411,355, filed Sep. 29, 2022, Provisional U.S. Patent Application No. 63/422,069, filed Nov. 3, 2022, and Provisional U.S. Patent Application No. 63/445,342, filed Feb. 14, 2023, the disclosure of all which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for DMRS enhancement.

A wireless transmit and receive unit (WTRU) may be configured to map code division multiplexing (CDM) groups to demodulation reference signal (DMRS) ports. The WTRU may send information associated with at least one of coherence capability or antenna layout of the WTRU to a base station. The information may comprise, for example, information identifying one or more coherent antenna groups. The information may indicate a number, e.g., one, two, etc., of coherent antenna groups comprised in the WTRU.

The base station, which may be, for example, a gNodeB, may receive the information associated with at least one coherence capability or antenna layout of the WTRU. The base station may determine, based on the information associated with at least one coherence capability or antenna layout, information scheduling a transmission and associating DMRS ports with CDM groups. The base station may send to the WTRU the information scheduling the transmission, which may be, for example, a PUSCH transmission, and associating DMRS ports with CDM groups. The information may be formatted as downlink control information (DCI).

The WTRU may receive the DCI from the base station. The DCI may comprise information scheduling a transmission and associating DMRS ports with CDM groups. The received information scheduling the transmission and associated DMRS ports with CDM groups may be based on the previously sent information identifying one or more coherent antenna groups.

The WTRU may determine a first one or more DMRS ports and a second one or more DMRS ports. The WTRU may, based on the DCI, associate the first one or more DMRS ports with a first CDM group and associate the second one or more DMRS ports with a second CDM group. The WTRU may map the first one or more DMRS ports associated with the first CDM group to a first antenna group and may map the second one or more DMRS ports associated with the second CDM group to a second antenna group.

The WTRU may send the scheduled transmission comprising, for example, at least a first DMRS sent using the first one or more DMRS ports and the first antenna group and at least a second DMRS sent using the second one or more DMRS ports and the second antenna group.

The WTRU may be configured to associate a phase tracking radio signal (PTRS) port with a DMRS port. The DCI that is received at the WTRU may specify a first PTRS port. The WTRU may determine, based on a modulation and coding scheme (MCS) value, a first DMRS port from the first one or more DMRS ports or the second one or more DMRS ports. The WTRU may determine the first DMRS port based on the MCS value associated with the first DMRS port being the highest MCS value associated with any of the first one or more DMRS ports or the second one or more DMRS ports. The WTRU may select the first DMRS port based on, for example, the MCS associated with the first DMRS port indicating that the first DMRS port is associated with a strong link, e.g., the strongest link, for uplink transmission. The WTRU may associate the first PTRS port with the first DMRS port mapped to the first antenna group. The transmission sent by the WTRU may comprise a PTRS sent using the PTRS port.

The DCI received at the WTRU may specify a plurality of ports including, for example, a first PTRS port and a second PTRS port. The WTRU may associate the first PTRS port with a first DMRS port mapped to the first antenna group and may associate the second PTRS port with a second DMRS port mapped to the second antenna group. The transmission sent by the WTRU may comprise the first PTRS sent using the first PTRS port and a second PTRS sent using the second PTRS port. The transmission may further comprise a physical uplink shared channel (PUSCH) transmission.

DMRS enhancements may include improved cross-panel DMRS interference management. A WTRU may be configured to determine a first antenna panel and a second antenna panel. The WTRU may receive DCI comprising a plurality of fields associated with antenna panels and may determine the first antenna panel and the second antenna panel based on the DCI. The DCI may further comprise an indication to simultaneously transmit using the first antenna panel and the second antenna panel. The WTRU may transmit using the first antenna panel and a first resource to a first TRP, and may simultaneously transmit using the second antenna panel and the first resource to a second TRP.

A WTRU may be configured to determine a first antenna panel is orthogonal to a second antenna panel. The WTRU may determine the first antenna panel is orthogonal to the second antenna panel based on a timing advance. The WTRU may determine, based on the first antenna panel being orthogonal to the second antenna panel, to simultaneously transmit from the first antenna panel and the second antenna panel. The WTRU may determine a third antenna panel is not orthogonal to the first antenna panel. The WTRU may determine to rate match around PUSCH resources of the third antenna panel.

A WTRU may be configured to determine a plurality of DMRS ports. The WTRU may determine a first group of DMRS ports and a second group of DMRS ports in the plurality of DMRS ports. The WTRU may associate the first group of DMRS ports with a first scheduled slot and associate the second group of DMRS ports with a second scheduled slot.

A WTRU may receive an indication that DMRS resource element positions are subject to change across PUSCH transmission instances. The WTRU may receive DCI and may determine, based on the DCI, a DMRS port for transmission. The WTRU may determine a DMRS port for transmission based on at least an uplink antenna port code in the DCI.

DMRS enhancements may include enhanced OCC mapping. A WTRU may be configured to determine a first group of OCC that spans over a first set of resource elements and determine a second group of OCC that spans over a second set of resource elements. The WTRU may determine at least one resource element is comprised in the first set of resource elements and in the second set of resource elements. The WTRU may determine that, for the at least one resource element, a cover code coefficient for a transmission port associated with the first group of OCC is the same as the cover code coefficient associated with the second group of OCC. For the same transmission port, the cover code coefficients used by different OCC groups over the shared resource elements may be the same. The transmission port may be a DMRS port.

DMRS enhancements may include increasing the number of DMRS ports. Increasing the number of DMRS ports may relate, for example, to new DMRS mapping patterns for SU/MU MIMO. A WTRU may be configured to receive information indicating a configuration for DMRS. The WTRU may determine a pattern for DMRS transmission based on the configuration for DMRS. The WTRU may determine, based on the pattern for DMRS transmission, a number of resource elements for an OFDM symbol. The WTRU may then determine, based on the configuration for DMRS, to apply an OCC length to a DMRS transmission and may send the DMRS transmission using the pattern for DMRS transmission. If the pattern for DMRS transmission is a first or second pattern, the WTRU may reduce the number of resource elements for the OFDM symbol to two resource elements, and depending on the DMRS configuration, may apply an OCC length of 2 or 4 to the DMRS transmission. If the pattern for DMRS transmission is a third or fourth pattern, the WTRU may reduce the number of resource elements for the OFDM symbol to one resource element, and depending on the DMRS configuration, may apply an OCC length of 4 or 8 to the DMRS transmission.

A WTRU may be configured to provide enhanced CDM grouping. The WTRU may determine a first plurality of DMRS ports and associate the first plurality of DMRS ports with a first CDM group. The WTRU may determine a second plurality of DMRS ports and associate the second plurality of DMRS ports with a second CDM group. The WTRU may communicate information using the first plurality of DMRS ports and using the second plurality of DMRS ports. One or more of the first plurality of DMRS ports and one or more of the second plurality of DMRS ports may be associated with the first CDM group. The resources associated with the first CDM group may be mutually exclusive to resources associated with the second CDM group. The WTRU may be further configured to determine one or more PTRS ports and associate the one or more PTRS ports with the first plurality of DMRS ports based on properties of the first plurality of DMRS ports.

A WTRU may be configured to provide enhanced DMRS mapping. The WTRU may be configured to determine a FD-OCC length associated with a FD-OCC. The WTRU may determine the FD-OCC length is associated with one or more orphan resource elements. If the WTRU determines the FD-OCC length is associated with one or more orphan resource elements, the WTRU may determine to shift the FD-OCC to align with a scheduled transmission. The WTRU may determine to shift the FD-OCC to align with the scheduled transmission based on a dynamic indication to shift the OCC mapping for a scheduled transmission. The dynamic indication may be received as part of scheduling DCI. The WTRU may determine to shift the FD-OCC to align with the scheduled transmission based on an index of a reference PRB of the scheduled transmission. The WTRU may determine to shift the FD-OCC to align with the scheduled transmission based on a set of indicated antenna ports. A first group of antenna ports may be associated with a first OCC mapping, and a second group of antenna ports may be associated with a second OCC mapping.

A WTRU may be configured to provide enhanced PTRS configuration. The WTRU may determine a plurality of antenna groups, wherein each of the plurality of antenna groups comprise a plurality of antennas. The WTRU may determine one or more DMRS ports for each of the plurality of antenna groups, associate each of the plurality of antenna groups with a CDM group, and associate one or more PTRS ports with each of the one or more DMRS ports. The WTRU may associate one or more PTRS ports with each of the one or more DMRS ports by determining a number of the plurality of antenna groups and determining a number of PTRS ports based on the number of the plurality of antenna groups. The WTRU may associate one or more PTRS ports with each of the one or more DMRS ports based at least in part on DCI. The WTRU may associate one or more PTRS ports with each of the one or more DMRS ports based at least in part on DCI and a MAC-CE.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2A depicts an example DMRS configuration type.

FIG. 2B depicts an example DMRS configuration type.

FIG. 3 depicts example spread of DMRS ports over slots.

FIG. 4 depicts example OCC.

FIG. 5 depicts an example of overlapping OCC.

FIG. 6 depicts an example of DMRS mapping with overlapped OCC.

FIG. 7 depicts example DMRS mapping for CP-OFDM waveform.

FIG. 8 depicts example DMRS mapping for CP-OFDM waveform.

FIG. 9 depicts example DMRS mapping for CP-OFDM waveform.

FIG. 10 depicts example DMRS mapping for CP-OFDM waveform.

FIG. 11 depicts example DMRS mapping for CP-OFDM waveform.

FIG. 12 depicts example DMRS mapping for CP-OFDM waveform.

FIG. 13 depicts example DMRS mapping for CP-OFDM waveform.

FIG. 14 depicts example DMRS port indication and selection.

FIG. 15 depicts an example MU-MIMO transmission.

FIG. 16 depicts an example table indicating PTRS-DMRS single port association.

FIG. 17 depicts an example table indicating configured subsets of PTRS-DMRS port association.

FIG. 18 depicts an example table indicating configured subsets of PTRS-DMRS port association for 2 ports.

FIG. 19 depicts example tables indicating pre-defined or pre-configured PTRS-DMRS port association.

FIG. 20 depicts example tables indicating a re-interpreted PTRS-DMRS port association.

FIG. 21 depicts example implementations for antenna group and PTRS-DMRS determination.

FIG. 22 depicts example CDM/DMRS mapping to an antenna group for an 8-layer transmission.

### DETAILED DESCRIPTION

A more detailed understanding may be had from the following description, given by way of example in conjunction with the accompanying drawings.

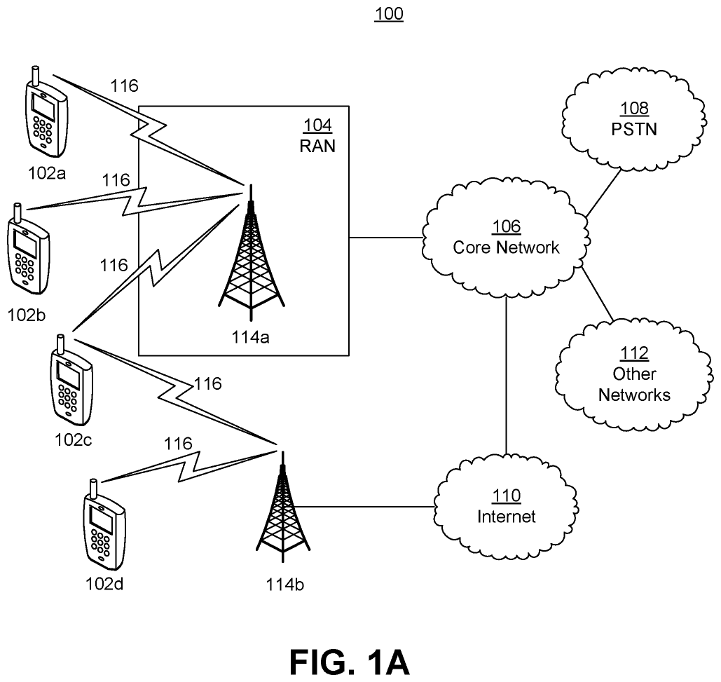

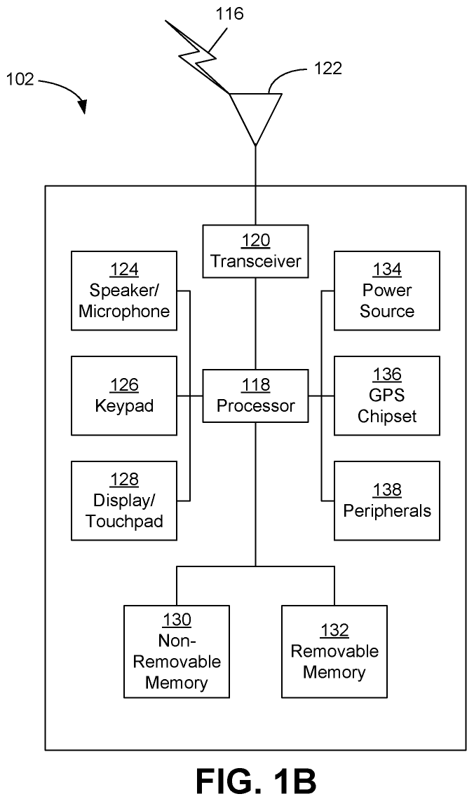

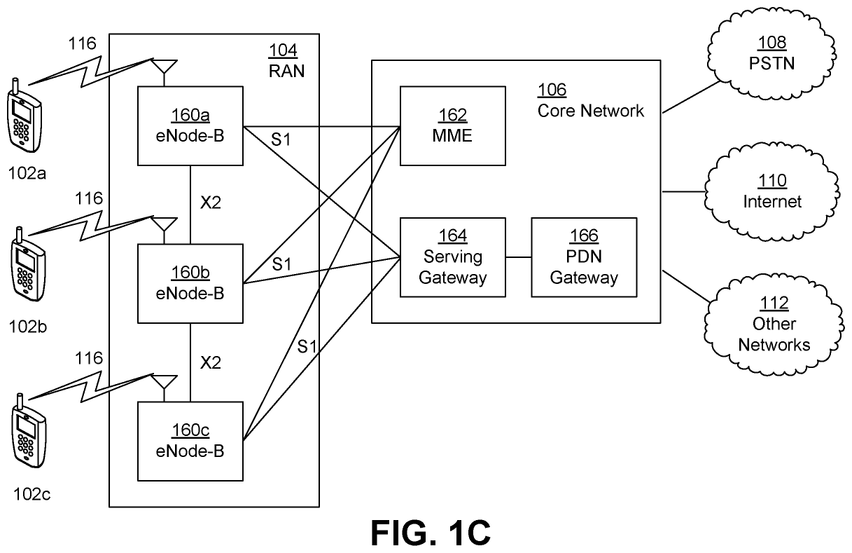

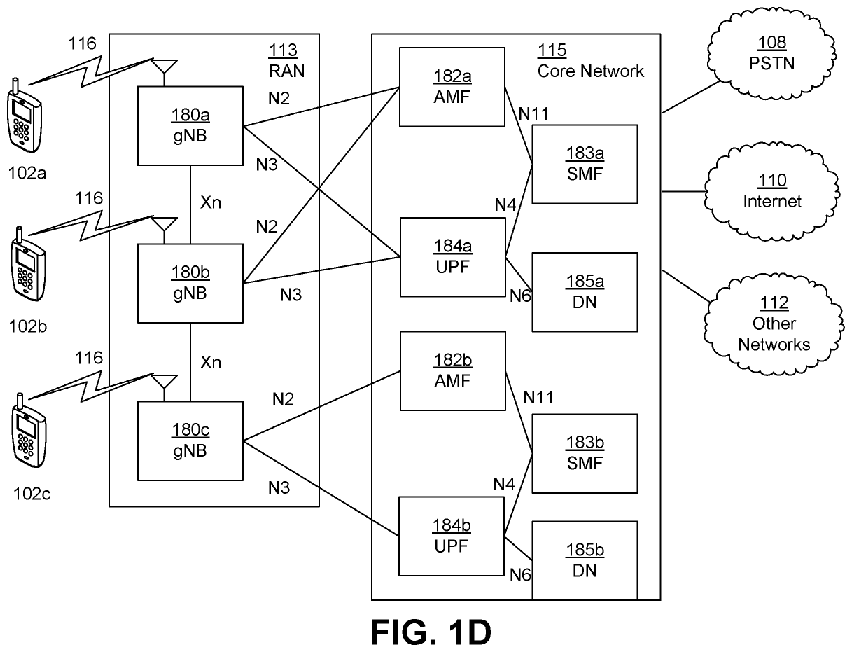

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform (DFT)-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports (e.g., only supports) a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The present application discloses DMRS enhancements. DMRS enhancements may relate, for example, to increasing the number of ports, supporting simultaneous multi-panel transmission, and/or supporting 8 TX WTRUS. The disclosed DMRS enhancements may include procedures for cross-panel DMRS interference management. Cross-panel DMRS interference management may relate, for example, to solutions for cross-panel DMRS pairing and orthogonal/non-orthogonal mapping. The disclosed DMRS enhancements may include procedures for enhanced OCC mapping. Enhanced OCC mapping may relate to using shared/overlapped OCC. The disclosed DMRS enhancements may include procedures for increasing the number of DMRS ports. Increasing the number of DMRS ports may relate, for example, to new DMRS mapping patterns for SU/MU MIMO. The disclosed enhancements may be applicable to and may be used for transmission of a signal that has a specific transmission pattern, e.g., in time, frequency, code domains, such as a demodulation reference signal, broadcast reference signal, etc. For the brevity of description, PUSCH DMRS or PDSCH DMRS may be discussed by way of example.

A Demodulation Reference Signal (DMRS) configuration that defines placement of reference signals in time and frequency may be designed to address a variety of scenarios with the aim of maintaining high design flexibility and forward compatibility, while addressing implementation complexity and constraints from the receiver perspective. The placement pattern of the pilot may be a part, e.g., a vital part, of the design of an efficient multiple-input and multiple-output (MIMO) communication system because the placement pattern may impact the number of orthogonal antenna ports supported for single user (SU)/multi-user (MU) MIMO (SU/MU-MIMO) transmission.

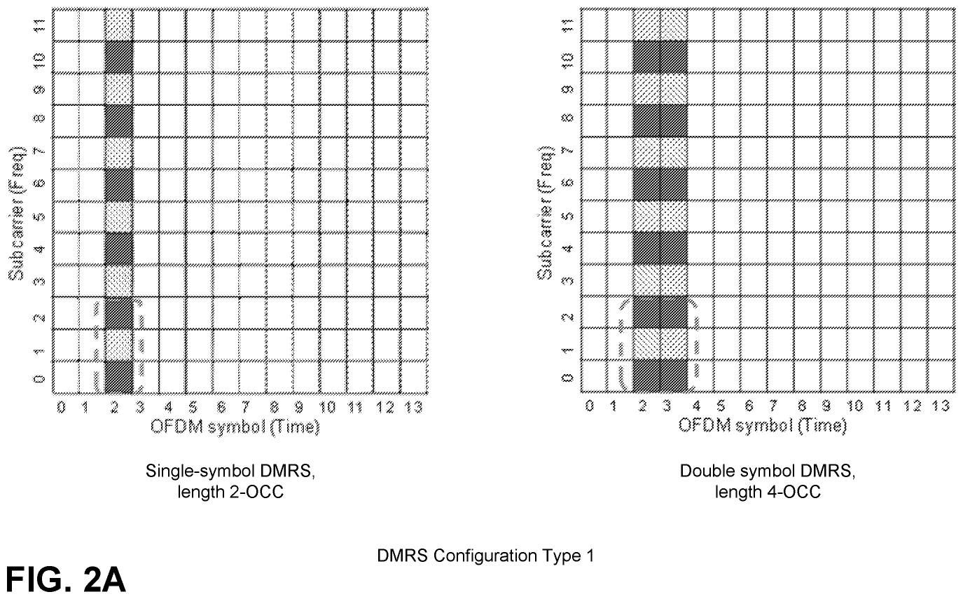

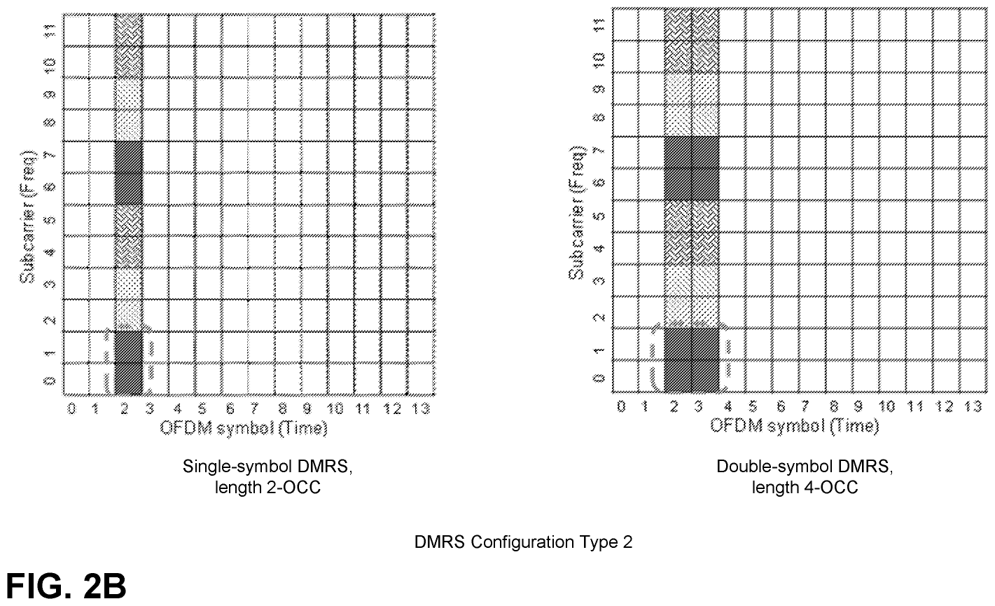

FIGS. 2A and 2B depict examples of DMRS configuration types for a Cyclic Prefix Orthogonal Frequency Division Multiplexing (CP-OFDM) waveform. A first example DMRS configuration type as depicted in FIG. 2A may be referred to as DMRS configuration Type 1. A second example DMRS configuration type as depicted in FIG. 2B may be referred to as DMRS configuration Type 2. Both example configurations may support single-symbol and a double-symbol DMRS mappings. To use the available resources efficiently, orthogonal cover codes (OCC) may be used to support multi-port operation of DMRSs. For example, in the shown single-symbol configuration, two antenna ports using the same resource elements may be orthogonalized by using a length 2-OCC, whereas for a double-symbol configuration, four antenna ports may be orthogonalized by using a length 4-OCC.

The DMRS configuration types may specify the density of the DMRS in the frequency domain and may determine a number, e.g., a maximum number, of orthogonal antenna ports that may be supported per physical resource block. A difference between the configuration types may be that DMRS configuration Type 1 may have a denser frequency domain occupancy of the pilots in comparison to DMRS configuration Type 2, which may make DMRS configuration Type 1 more resilient to frequency domain channel variations. On the other hand, DMRS configuration Type 2 may have more orthogonal antenna ports (although there may be a trade-off of reduced DMRS density). Thus, DMRS configuration Type 1 may support up to 4 orthogonal ports for a single-symbol configuration and up to 8 orthogonal ports for a double-symbol configuration. DMRS configuration Type 2 may support up to 6 orthogonal ports for a single-symbol configuration and up to 12 orthogonal ports for a double-symbol configuration, which may make DMRS configuration Type 2 more suitable for MU-MIMO.

In connection with MIMO, to enhance coverage, reliability, and throughput, for certain categories of WTRUs, enhancements for uplink transmission may be considered. DMRS enhancements may be employed to support the following features.

A first feature may be to specify larger numbers of orthogonal DMRS ports for downlink and uplink MU-MIMO (e.g., with or without increasing the DM-RS overhead), for, e.g., only for, CP-OFDM. The feature may strive for a common design between DL and UL DMRS. The feature may employ up to, for example, 24 orthogonal DM-RS ports, where for each applicable DMRS type, the maximum number of orthogonal ports may be doubled for both single-symbol and double-symbol DMRS.

A second feature may be to specify UL DMRS, SRS, SRI, and TPMI (including codebook) enhancements to enable 8 Tx UL operation to support 4 and more layers per WTRU in UL targeting CPE/FWA/vehicle/Industrial devices. Potential restrictions on the scope of this feature (including, for example, coherence assumption, full/non-full power modes) may be identified.

A third feature may be to specify the following items to facilitate simultaneous multi-panel UL transmission for higher UL throughput/reliability, focusing on FR2 and multi-TRP, assuming up to 2 TRPs and up to 2 panels, and targeting CPE/FWA/vehicle/industrial devices (if applicable). A feature may comprise providing an UL precoding indication for PUSCH, where no new codebook may be introduced for multi-panel simultaneous transmission. The total number of layers may be up to four across all panels and a total number of codewords may be up to two across all panels, considering single DCI and multi-DCI based multi-TRP operation. The feature may provide an UL beam indication for PUCCH/PUSCH, where unified TCI framework extension in objective 2 may be assumed, considering single DCI and multi-DCI based multi-TRP operation. For multi-DCI based multi-TRP operation, PUSCH+PUSCH, e.g., only PUSDH+PUSCH, or PUCCH+PUCCH may be transmitted across two panels in a same CC.

Disclosed herein are DMRS enhancements. DMRS enhancements may relate, for example, to increasing the number of ports, supporting simultaneous multi-panel transmission, and/or supporting 8 TX WTRUs. The disclosed DMRS enhancements include procedures for cross-panel DMRS interference management. Cross-panel DMRS interference management may relate, for example, to solutions for cross-panel DMRS pairing and orthogonal/non-orthogonal mapping. The disclosed DMRS enhancements may include procedures for enhanced OCC mapping. Enhanced OCC mapping may relate to using shared/overlapped OCC. The disclosed DMRS enhancements may include procedures for increasing the number of DMRS ports. Increasing the number of DMRS ports may relate, for example, to new DMRS mapping patterns for SU/MU MIMO.

Procedures for cross-panel DMRS interference management may be provided. DMRS interference management may involve inter-panel DMRS pairing. A WTRU may receive a grant scheduling a PUSCH transmission with its associated DMRS. The grant may contain a field indicating the antenna port configuration for the WTRU. In the single DCI (sDCI) case, a WTRU may receive one antenna port field. If single TRP is used, a WTRU may determine that the antenna port may be associated with the DMRS transmission to one TRP. If multi-TRP (mTRP) repetition is scheduled, a WTRU may determine that the same antenna port configuration may be used for transmissions towards both TRPs. If TDM′d transmission are used, PUSCH transmission may comprise repetitions scheduled in different time instances (e.g., symbols or slots). A WTRU may be capable of using more than one panel to simultaneously transmit PUSCH in the same slot or symbol towards more than one TRP. We may denote this mode of operation as Simultaneous Multi-Panel (SMP).

A WTRU may receive a sDCI with more than one antenna port field, where each antenna port field may be independently configured per WTRU panel for SMP. A WTRU may determine the antenna ports per panel based on the ordering of the antenna port fields in the DCI. For example, a first antenna port may be associated with a first panel, TCI, or PMI, and a second antenna port may be associated with a second panel, TCI, or PMI.

A WTRU may determine that a single antenna port field may be associated with more than one panel. If a WTRU determines that the grant is scheduling the WTRU in SMP mode (e.g., explicitly or through SRI/TCI, TPMI/PMI indication), a WTRU may determine that a first set of ports may be associated with the first panel, and a second set of ports may be associated to the second panel. A WTRU may receive a DMRS port indication of {0,1}, and an explicit bit field flag in the grant indicating SMP mode of operation. A WTRU may use port 0 for a first antenna panel and may use port 1 for a second antenna panel.

Reserved fields from the antenna port indication (e.g., values 12-15) may be reused for indicating SMP mode of operation. A WTRU may select to transmit in SMP when it receives a grant indicating these values. Each value may be mapped to a different antenna port combination and assignment per panel (e.g., SMP with port 0 panel 0 and port 1 panel 1; SMP with port 0-1 panel 0 and port 2 panel 1; etc., . . . ).

A WTRU may receive a MAC-CE or UL-TCI which may contain indication of DMRS port pairs for SMP. A WTRU may use the indication of SMP DMRS port pairs in addition to the antenna port indication to determine if the PUSCH is scheduled in SMP mode and the port assignment per panel. A WTRU may receive an antenna port indication to use ports 0 and 1. A WTRU may receive an indication that ports 0 and 1 may be paired for SMP. The WTRU may send port 0 and port 1 simultaneously on panel 0 and 1, respectively.

In multi-DCI mode (mDCI), a WTRU may receive separate DCIs where each DCI may be sent from a different TRP. A WTRU may receive separate antenna port indication from each grant. An additional field may be included as part of the antenna port indication to indicate whether SMP scheduling is done between antenna ports. For example, if a WTRU receives antenna port 0 indication for panel 0, and antenna port 1 indication for panel 1, and a bit indicating SMP, a WTRU may determine to transmit in SMP mode. A WTRU may receive a resource assignment in time/frequency which may, e.g., may only, partially overlap between two mDCIs. A WTRU may select to do SMP when, e.g., only when, the resource assignments overlap.

DMRS mapping for SMP may be provided. A WTRU may be indicated to use rate-matching to achieve a desired coded sequence length. For example, a WTRU may map its PUSCH transmission onto a set of RE, with the exception of rate-matched REs (i.e., skipped REs) where a WTRU does not transmit. A WTRU may be required to omit some coded bits from the output of the channel coder. The omitted bits may be defined as punctured from the sequence. Different puncturing patterns may be configured to reduce interference on the rate-matched REs on the uplink or downlink. In SMP mode of operation, we may consider inter-panel interference as well, and rate-matching patterns may be used to mitigate the interference.

A WTRU may determine different rate-matching patterns depending on its panel orthogonality. A WTRU may consist of one or more antenna panels, and the antenna panels may have different orientations. For example, one antenna panel may be pointing outwards from the front of the device, while another antenna panel may be pointing outwards from the back of the device. From a perspective of associated interference, these directions may be quasi orthogonal since the spatial filter may be pointing in opposite directions. A WTRU may be able to transmit simultaneously from both of these panels with low inter-panel interference. A WTRU may not rate-match around the PUSCH resources of the other panel if this is the case.

A WTRU may indicate, as part of its capability, pairs of panels with low inter-panel interference. A WTRU may also indicate it as part of a CSI report with the associated CRI indices per panel. For example, panel 1 and panel 2 may have low inter-panel interference. Based on this capability, a WTRU may be scheduled for transmission on panel 1 and panel 2 simultaneously.

A WTRU may determine which panels are orthogonal based on the Timing Advance (TA). If the difference between the TA of two panels is less than a threshold, a WTRU may determine that the two panels are orthogonal, and otherwise non-orthogonal.

A WTRU may receive a configuration for DMRS with more than one scrambling ID. A DMRS sequence may be generated using a scrambler with a seed initiated by a scrambling ID. A WTRU may select two different scrambling IDs and may apply one per DMRS sequence used per panel if the panels are not orthogonal to further reduce inter-panel interference. Otherwise, a WTRU may reuse the same scrambling ID for both panels.

A WTRU may determine to rate match as a function of panel orthogonality. If panels are orthogonal, a WTRU may determine to not apply the rate matching; otherwise, a WTRU may rate match. A WTRU may include in a UCI an indication of whether a WTRU applies rate matching or not, and for which antenna ports/CDM groups it applies. A WTRU may indicate the preferred CDM grouping for SMP as part of WTRU capability, or as part of a MAC-CE for SMP where a WTRU may indicate panel pairing/association to the network. Alternatively, a WTRU may receive a preconfigured rate-matching pattern when considering different panels. Rate matching patterns may be defined as a function of OCC patterns or CDM groups used for SMP.

A WTRU may determine to rate match one PUSCH transmission around the DMRS of the other simultaneous PUSCH transmission when a WTRU is scheduled in SMP mode. A WTRU may determine two different DMRS allocation where each DMRS allocation is associated with a respective panel. A WTRU may receive a rate matching pattern which a WTRU may apply, e.g., apply only, when transmitting in SMP mode. Alternatively, a WTRU may indicate the port pairs which may be used for SMP and may indicate the rate matching pattern it is using. The ports may belong to the same or different CDM groups.

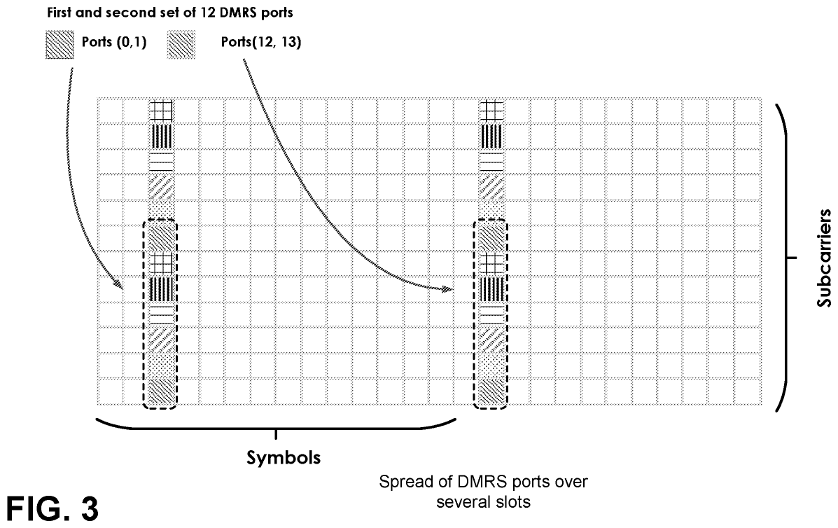

Spread DMRS transmission may be provided. To increase the capacity of transmission ports, e.g., DMRS ports, the DMRS ports may be divided into more than one group, where a first set of DMRS ports may be sent in a first scheduled slot, and a second set of DMRS ports may be sent in a second scheduled slot, etc. FIG. 3 depicts an example of spreading DMRS ports over several slots. In the example depicted in FIG. 3, to support 24 DMRS ports with an OCC length of 2, a first set of 12 DMRS ports may be sent in a first slot, and a second set of DMRS ports may be sent in a second slot. For a given port, the mapping of DMRS in frequency domain may be changed in every transmission.

A WTRU may receive an indication/configuration that DMRS RE positions (and/or phase-tracking RS (PTRS) RE positions) may be changing (e.g., being shifted based on a pre-configured/pre-defined pattern) across PUSCH transmission instances, where each of the PUSCH transmission instances may be scheduled based on receiving a same codepoint of a DMRS-related field (e.g., ‘Antenna ports’ field) in a DCI scheduling each of the PUSCH (and/or based on receiving a same second codepoint of a PTRS-related field, e.g., a ‘PTRS-DMRS association’ field). In an example, the WTRU may (e.g., may be configured to) transmit DMRS (only) on a selected subset of DMRS ports that may be defined per RB and/or slot, e.g., based on the indication/configuration. The WTRU may determine the DMRS port(s) for transmission from an uplink antenna port indication in a scheduling DCI. Based on the determined DMRS port(s) for transmission, the WTRU may determine (e.g., update) an association of a PTRS port with at least one of the determined DMRS port(s).

The codepoint may be pre-configured by RRC and/or activated by a MAC-CE, e.g., indicating/comprising at least one of a number of DMRS antenna ports which may correspond to a total number of PUSCH layers. Each DMRS port number may correspond to each PUSCH layer of the PUSCH layers, number of DMRS CDM group(s) without data, and number of front-load symbols, etc., where the number of DMRS antenna ports may be indicated by a separated field (e.g., precoding information and number of layers' field). The second codepoint of the PTRS-related field may be pre-configured by RRC and/or activated by a MAC-CE, e.g., indicating association(s) between PTRS port(s) and DMRS port(s).

The WTRU may determine, on a first PUSCH transmission instance (e.g., scheduled by a first DCI scheduling a first PUSCH) of the PUSCH transmission instances, first one or more DMRS RE positions corresponding to the each DMRS port number indicated by a codepoint C in a field (e.g., the ‘Antenna ports’ field) of the first DCI, and/or first one or more PTRS RE positions indicated by a codepoint D of the PTRS-related field. In response to the determination, the WTRU may transmit the first PUSCH and DMRSs and/or PTRS(s) (being associated with or along with the first PUSCH) based on the first one or more DMRS RE positions and/or the first one or more PTRS RE positions.

The WTRU may determine, on a second PUSCH transmission instance (e.g., scheduled by a second DCI scheduling a second PUSCH) of the PUSCH transmission instances, second one or more DMRS RE positions corresponding to the each DMRS port number indicated by a (e.g., a same) codepoint C in a field (e.g., the ‘Antenna ports’ field) of the second DCI, and/or second one or more PTRS RE positions indicated by a (e.g., a same) codepoint D of the PTRS-related field, in response to receiving the indication/configuration that DMRS/PTRS RE positions may be changing across PUSCH transmission instances. In response to the determination, the WTRU may transmit the second PUSCH and DMRSs and/or PTRS(s) (being associated with or along with the second PUSCH) based on the second one or more DMRS RE positions and/or the second one or more PTRS RE positions. The second one or more DMRS RE positions may be determined as a frequency-domain shifted version (e.g., X-RE up or down, e.g., X=1, 2, . . . or, X_max) of the first one or more DMRS RE positions, based on the indication/configuration. The parameter/value of X may be indicated or configured to the WTRU. The second one or more PTRS RE positions may be determined as a frequency-domain shifted version (e.g., P-RE up or down, e.g., P=1, 2, . . . or, P_max) of the first one or more PTRS RE positions based on the indication/configuration. The parameter/value of P may be indicated or configured to the WTRU. X and P may be the same/identical (or indicated using a single parameter), based, for example, on the indication/configuration.

The WTRU may determine, on a third PUSCH transmission instance (e.g., scheduled by a third DCI scheduling a third PUSCH) of the PUSCH transmission instances, third one or more DMRS RE positions corresponding to each DMRS port number indicated by a (e.g., a same) codepoint C in a field (e.g., the ‘Antenna ports’ field) of the third DCI, and/or third one or more PTRS RE positions indicated by a (e.g., a same) codepoint D of the PTRS-related field, in response to receiving the indication/configuration that DMRS/PTRS RE positions may be changing across PUSCH transmission instances. In response to the determination, the WTRU may transmit the third PUSCH and DMRSs and/or PTRS(s) (being associated with or along with the third PUSCH) based on the third one or more DMRS RE positions and/or the third one or more PTRS RE positions. In examples, the third one or more DMRS RE positions may be determined as a frequency-domain shifted version (e.g., Y-RE up or down, e.g., Y=1, 2, . . . or, Y_max) of the first (or second) one or more DMRS RE positions, based on the indication/configuration. The parameter/value of Y may be indicated or configured to the WTRU. The third one or more PTRS RE positions may be determined as a frequency-domain shifted version (e.g., Q-RE up or down, e.g., Q=1, 2, . . . or, Q_max) of the first (or second) one or more PTRS RE positions, based on the indication/configuration. The parameter/value of Q may be indicated or configured to the WTRU. Y and Q may be the same/identical (or indicated using as a single parameter), based, for example, on the indication/configuration.

X and Y may be the same/identical (or indicated using a single parameter), based, for example, on the indication/configuration. P and Q may be the same/identical (or indicated using a single parameter) based, for example, on the indication/configuration. The third one or more DMRS (and/or PTRS) RE positions may be the same as (e.g., identical to) the first one or more DMRS (and/or PTRS) RE positions based, for example, on the indication/configuration, which may imply there are two alternating patterns on the DMRS (and/or PTRS) RE positions as in the following example order across the PUSCH transmission instances: first one or more DMRS (and/or PTRS) RE positions; second one or more DMRS (and/or PTRS) RE positions; first one or more DMRS (and/or PTRS) RE positions; second one or more DMRS (and/or PTRS) RE positions; and so on.

A gNB (or a second WTRU, e.g., in sidelink) receiving at least the DMRSs (and/or PTRS) transmitted on the first one or more DMRS (and/or PTRS) RE positions and the second one or more DMRS (and/or PTRS) RE positions across the PUSCH transmission instances may apply an (e.g., time/frequency-domain) interpolation for wireless channel estimation (and/or the channel's phase tracking) based on at least the DMRSs (and/or PTRS) across the PUSCH transmission instances, and for use receiving at least one of the first PUSCH, the second PUSCH, and the third PUSCH, etc. This may improve uplink performance (e.g., in terms of UL throughput and/or reliability) based on an effect of increasing DMRS (and/or PTRS) density (e.g., in frequency-domain) based on the frequency-domain shifted version among at least the DMRSs across the PUSCH transmission instances, which may improve the wireless channel estimation performance.

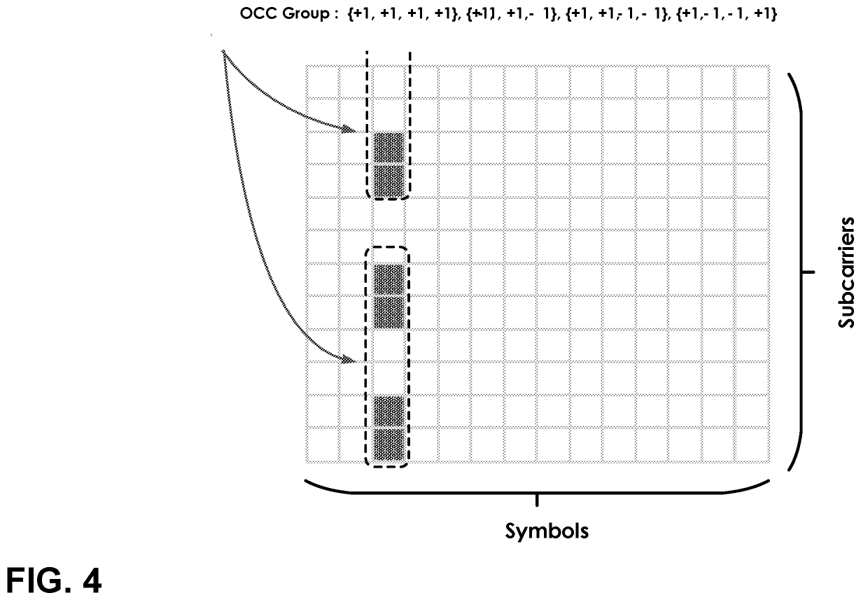

DMRS mapping with overlapped OCC may be provided. OCCs may be used to support multiplexing of transmission ports of reference signals. FIG. 4 depicts an example use case of OCC for multiplexing of 4 DMRS ports. An example of OCC with length 4 and without overlapped OCC is shown. There may be no overlap of the OCCs applied on different resources, and a same OCC group may be used for the entire scheduled band. A shortcoming of such design may be that it may not always be possible to have an RB with self-contained OCCs. As shown in FIG. 4, while the first OCC may be entirely within the first scheduled RB, the second OCC may not, and it may be extended to the adjacent RB. Therefore, if a WTRU is not scheduled with the adjacent RB, some of the DMRSs may not be usable for channel estimation.

A multi-port reference signal may be multiplexed using over-lapped OCCs. A WTRU may send a multi-port reference signal using overlapped OCCs. A WTRU may receive a multi-port reference signal using overlapped OCCs.

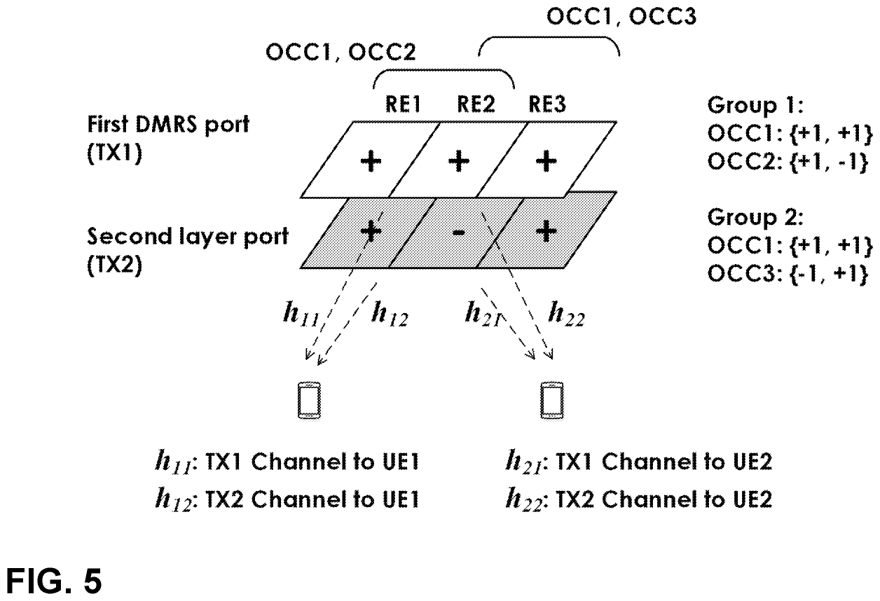

FIG. 5 illustrates a basic principle of overlapped OCCs for a multi-port DMRS. Referring to FIG. 5, an OCC with a length of 2 is presented. The presented concept is equally applicable for other OCC lengths as well. The presented principle may be used for a variety of other uses including, for example, the following: multiplexing and transmission of other types of signals, e.g., CSI-RS, etc.; multiplexing of signals in other domains, e.g., time domain, etc.; either uplink or downlink transmissions; and/or cross-panel, cross-TRP port mapping, etc.

As illustrated in FIG. 5, more than one group of OCCs may be used. A first group of OCCs may span over a first set of resource elements, and a second group of OCCs may span over a second set of resource elements. Some resource elements may be covered by more than one cover code where, for a same transmission port, the cover code coefficients used by different OCC groups over the shared resource elements may be the same. For example, as shown in FIG. 5, at the shared location RE2, for each DMRS port, the OCC coefficients used by both groups is the same, e.g., +1 for Group 1 and −1 for Group 2.

As shown in FIG. 5, assuming an equal channel over adjacent REs, the estimated channel for each DMRS port may be estimated as indicated in the following chart:

| | UE1 | UE2 |
|---|---|---|
| Received signals | RE1: r₁ = h₁₁ + h₁₂ | RE2: r₂ = h₂₁ − h₂₂ |
| | RE2: r₂ = h₁₁ − h₁₂ | RE3: r₃ = h₂₁ + h₂₂ |
| | h₁₁ = (r₁ + r₂)/2 | h₂₁ = (r₂ + r₃)/2 |
| | h₁₂ = (r₁ − r₂)/2 | h2₂ = (−r₂ + r₃)/2 |

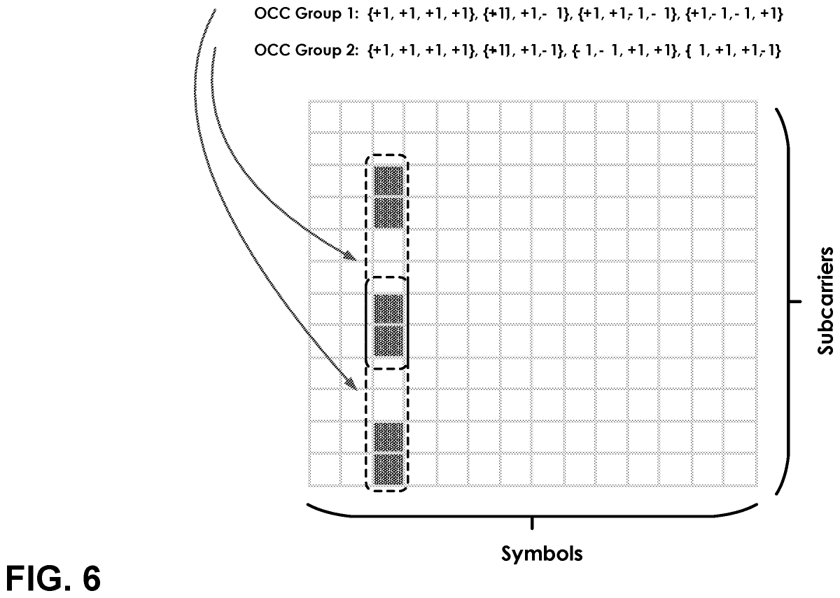

FIG. 6 shows an example of DMRS mapping with overlapped OCC length 4. In contrast to the mapping shown in FIG. 4, it may not be necessary to have more than one RB scheduled to be able to have OCC mapping for all DMRSs within a given RB. As shown in FIG. 6, each RB may be self-contained with two overlapped OCCs, and there may be no need to group DMRS REs of different RBs to be able to perform a complete channel estimation. It will be appreciated that while the text refers DMRS mapping with overlapped OCCs, the disclosed concepts for performing DMRS mapping may likewise apply to, for example, overlapping CDM groups.

Enhanced DMRS mappings may be provided. The PDSCH and PUSCH (e.g., without transform precoding) DMRS design patterns may support up to 12 orthogonal antenna ports for SU/MU-MIMO transmission. In order to improve MIMO transmission system capacity, it may be useful that DMRS design enhancements support more orthogonal ports without increasing the DMRS overhead in an existing NR architecture. PDSCH (or PUSCH) DMRS configuration patterns for a CP-OFDM waveform that support up to 24 orthogonal DMRS ports may be considered.

A WTRU may receive a configuration of DMRS where the number of ports may be greater than 12. A WTRU may determine a pattern for DMRS transmission as a function of the received DMRS configuration. A WTRU may transmit the DMRS according to one of the patterns discussed herein.

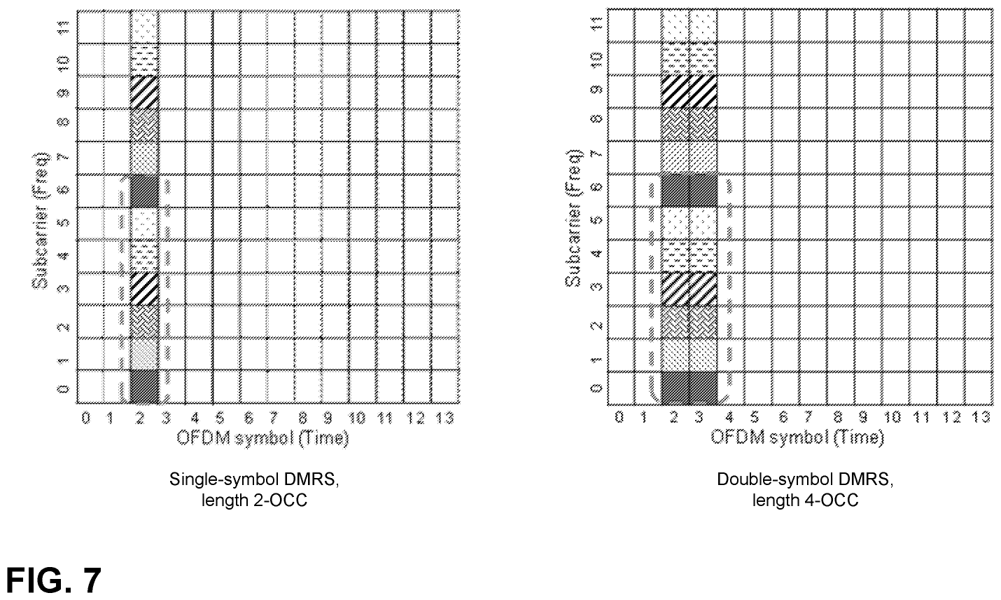

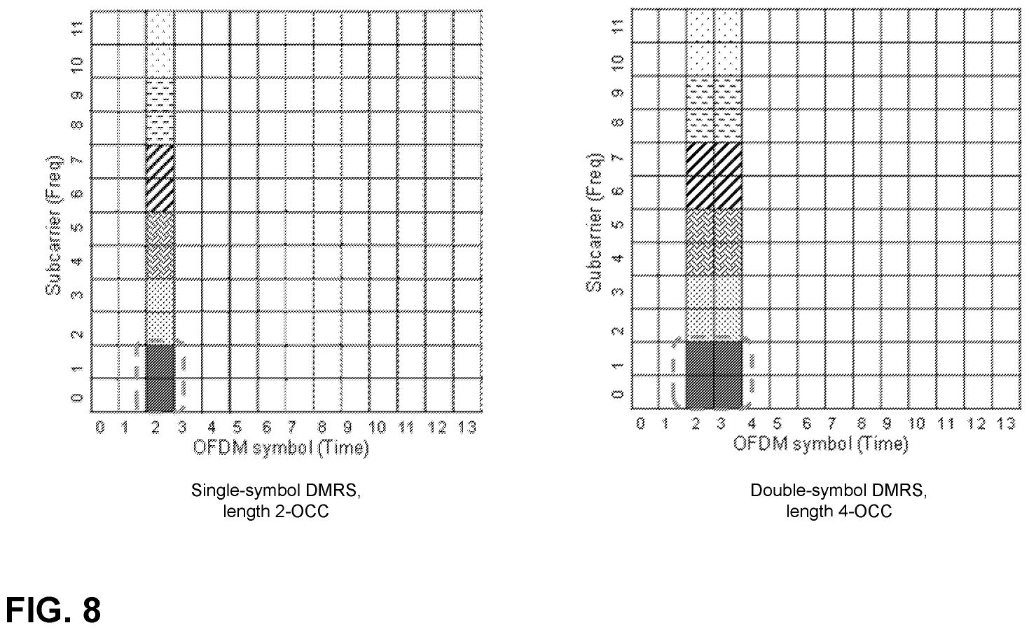

A first example pattern (“pattern 1”) may correspond to a DMRS mapping for CP-OFDM waveform as depicted in FIG. 7. A second example pattern (“pattern 2”) may correspond to a DMRS mapping for CP-OFDM waveform as depicted in FIG. 8. The number of RE allocation for DMRS pilots per OFDM symbol may be reduced to accommodate scenarios where the support for more than 12 orthogonal DMRS ports is required for DMRS configuration type 1 and 2. For the proposed DMRS patterns 1 and 2, shown in FIGS. 7 and 8, respectively, the number of REs per OFDM symbol is reduced to 2 REs to support up to 24 orthogonal DMRS port. OCC may be used to support multi-port operation. Depending on the DMRS configuration, a WTRU may transmit DMRS using a length 2-OCC for the single-symbol or a length 4-OCC for the double-symbol DMRS configuration. Hence, DMRS patterns 1 and 2 may support up to 12 orthogonal DMRS ports for the single-symbol configuration and up to 24 orthogonal DMRS ports for the double-symbol configuration.

A WTRU may receive a semi-static or a dynamic first configuration which may comprise a configuration for a specific OCC length. A WTRU may receive, for example, a configuration for a length of 2-OCC. As demonstrated in FIG. 7 and FIG. 8, the separation between the first and second RE of an OCC may be different. A WTRU may determine the separation between the REs of an OCC pattern based on a dynamic indication. A WTRU may receive a dynamic indication, e.g., a MAC CE or a DCI, to indicate the RE's separation implicitly or explicitly within a configured OCC. For example, a WTRU may receive an indication to assume a separation of 6 REs as demonstrated in FIG. 7.

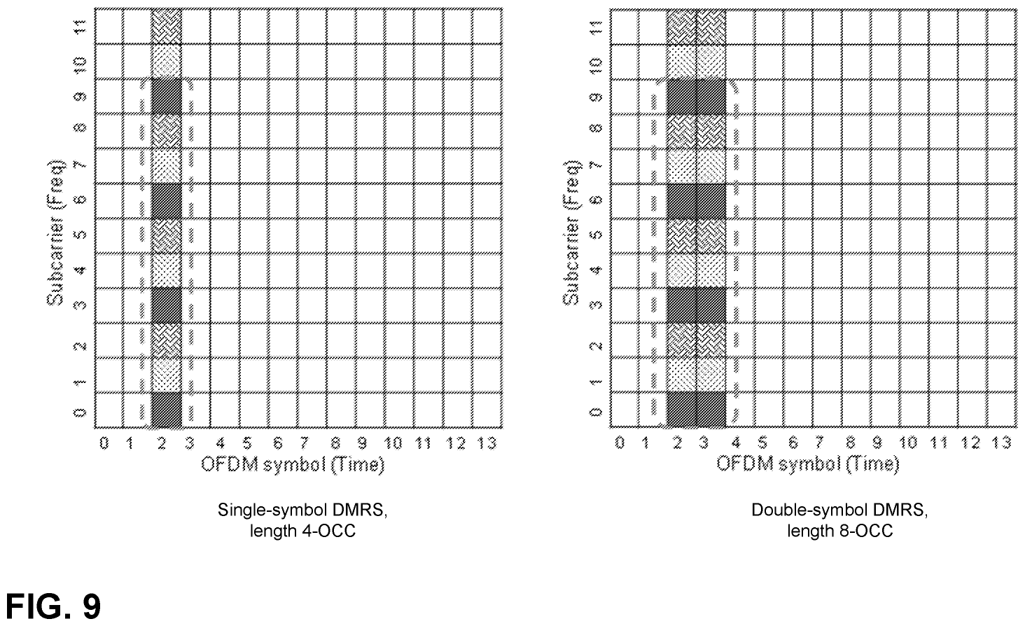

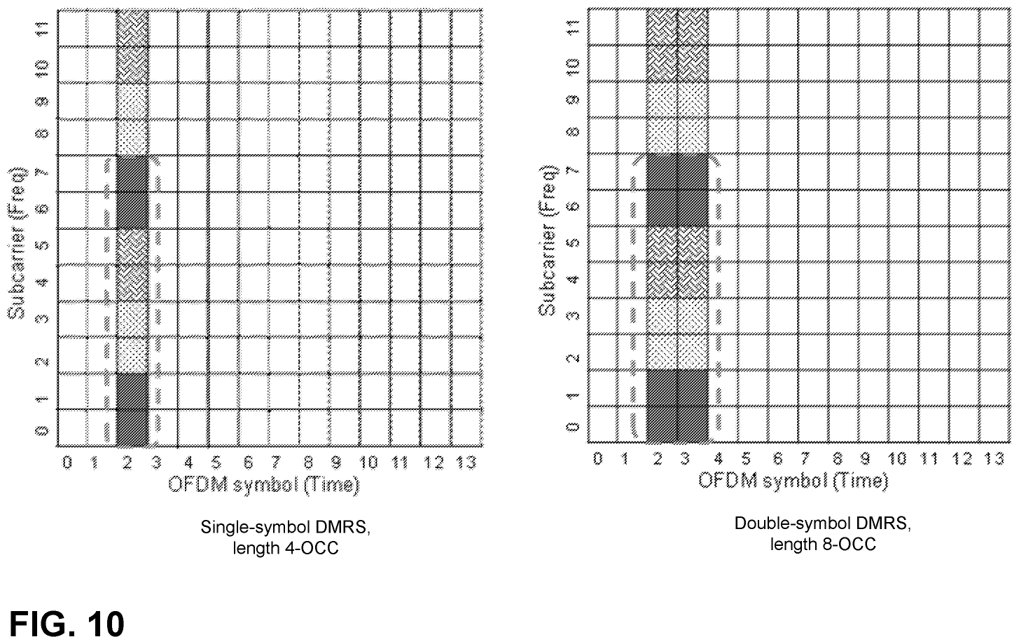

A third example pattern (“pattern 3”) may correspond to a DMRS mapping for CP-OFDM waveform as depicted in FIG. 9. A fourth example pattern (“pattern 4”) may correspond to a DMRS mapping for CP-OFDM waveform as depicted in FIG. 10. FIGS. 9 and 10 illustrate OCC with longer lengths that may be considered as a mechanism to increase the number of orthogonal DMRS ports in different use case scenarios. For single-symbol DMRS configuration in DMRS patterns 3 and 4, four antenna ports using the same REs may be orthogonalized by using a length 4-OCC. Conversely, for double-symbol DMRS configuration, 8 antenna ports sharing the same RE are orthogonalized using a length 8-OCC. DMRS patterns 3 and 4 may support up to 12 orthogonal DMRS ports for the single-symbol configuration and up to 24 orthogonal DMRS ports for the double-symbol configuration.

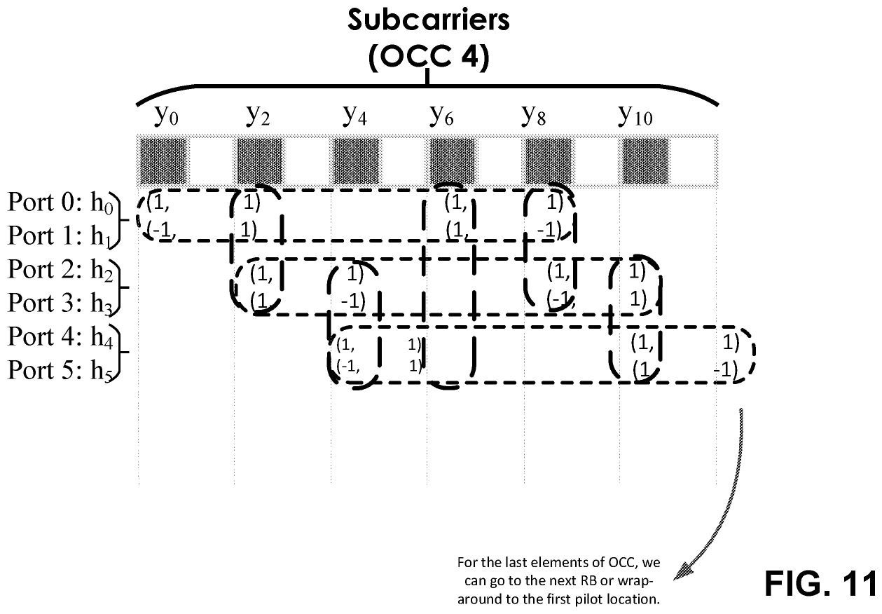

Example patterns may comprise overlapping OCCs. FIG. 11 depicts an example single-symbol 6-port DMRS mapping for CP-OFDM waveform using overlapped OCC with a length of 4. A WTRU may be configured to transmit or receive DMRS over 12 different DMRS ports using such a pattern, where the REs illustrated using dark shading may be utilized for the first set of 6 ports, and the REs illustrated in white may be used for the second set of 6 ports. By employing two (2) symbols, and following the presented principle, the overall DMRS capacity may be increased to 24 ports.

In FIG. 11, an exemplary set of OCC codes for each port are shown. Other OCC codes may be used as well.

A WTRU may use a set of OCCs where the elements of each overlapping OCCs may be the same on the overlapped RE. In FIG. 11, the second elements of OCCs associated with ports 1 and 2 may be the same as the first elements of OCCs associated with ports 3 and 4.

In an alternative with a mapping similar to FIG. 11, for the last elements of OCC, we may go to the next RB or wrap-around to the first pilot locations.

For the exemplary 6-port DMRS mapping shown in FIG. 11, a channel estimated hᵢ for each port may be computed based on measurements on each DMRS location,

$$[ \begin{matrix}{y}_{0} \\ {y}_{2} \\ {y}_{4} \\ {y}_{6} \\ {y}_{8} \\ {y}_{10}\end{matrix} ] = C [ \begin{matrix}{h}_{0} \\ {h}_{1} \\ {h}_{2} \\ {h}_{3} \\ {h}_{4} \\ {h}_{5}\end{matrix} ] \to [ \begin{matrix}{h}_{0} \\ {h}_{1} \\ {h}_{2} \\ {h}_{3} \\ {h}_{4} \\ {h}_{5}\end{matrix} ] = {C}^{- 1} [ \begin{matrix}{y}_{0} \\ {y}_{2} \\ {y}_{4} \\ {y}_{6} \\ {y}_{8} \\ {y}_{10}\end{matrix} ]$$

where C is the matrix containing the cover-codes. For the example shown in FIG. 11,

$$C = [ \begin{matrix}1 & - 1 & 0 & 0 & 0 & 0 \\ 1 & 1 & 1 & 1 & 0 & 0 \\ 0 & 0 & 1 & - 1 & 1 & - 1 \\ 1 & 1 & 0 & 0 & 1 & 1 \\ 1 & - 1 & 1 & - 1 & 0 & 0 \\ 0 & 0 & 1 & 1 & 1 & 1\end{matrix} ] , \\ {C}^{- 1} = [ \begin{matrix}0.5 & 0.25 & 0 & 0.25 & 0 & - 0.25 \\ - 0.5 & 0.25 & 0 & 0.25 & 0 & - 0.25 \\ - 0.5 & 0.25 & 0 & - 0.25 & 0.5 & 0.25 \\ 0.5 & 0.25 & 0 & - 0.25 & - 0.5 & 0.25 \\ 0.5 & - 0.25 & 0.5 & 0.25 & - 0.5 & 0.25 \\ - 0.5 & - 0.25 & - 0.5 & 0.25 & 0.5 & 0.25\end{matrix} ]$$

For the mapping in FIG. 11, other examples of cover code matrix C may be considered, for example,

$$C = [ \begin{matrix}1 & - 1 & 0 & 0 & 0 & 0 \\ 1 & 1 & 1 & - 1 & 0 & 0 \\ 0 & 0 & 1 & 1 & 1 & - 1 \\ 1 & 1 & 0 & 0 & 1 & 1 \\ 1 & - 1 & 1 & 1 & 0 & 0 \\ 0 & 0 & 1 & - 1 & 1 & 1\end{matrix} ] , \\ where \\ {C}^{- 1} = [ \begin{matrix}0.5 & 0.25 & 0 & 0.25 & 0 & - 0.25 \\ - 0.5 & 0.25 & 0 & 0.25 & 0 & - 0.25 \\ - 0.5 & 0.25 & 0 & - 0.25 & 0.5 & 0.25 \\ 0.5 & - 0.25 & 0 & 0.25 & 0.5 & - 0.25 \\ 0.5 & - 0.25 & 0.5 & 0.25 & - 0.5 & 0.25 \\ - 0.5 & - 0.25 & - 0.5 & 0.25 & 0.5 & 0.25\end{matrix} ] .$$

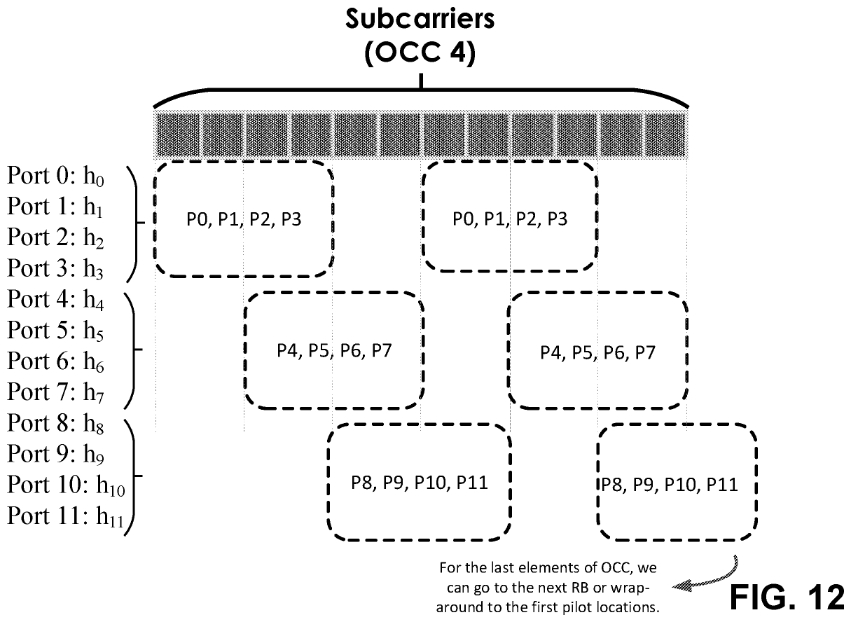

FIG. 12 depicts an example single symbol DMRS supporting 12-port DMRS mapping using overlapped OCC with a length of 4. A WTRU may be configured to transmit or receive DMRS over 12 different DMRS ports using such pattern. By employing two (2) symbols, and following the presented principle, the overall DMRS capacity may be increased to 24 ports.

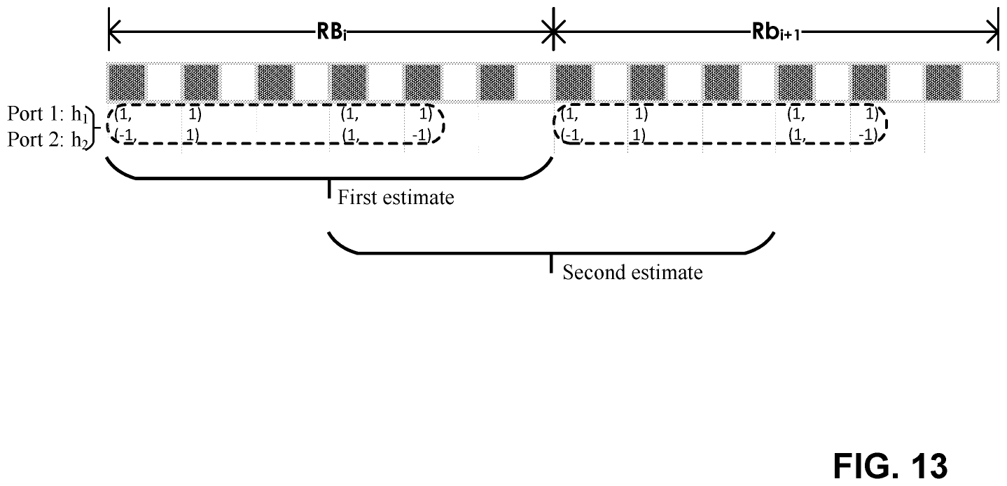

Enhanced accuracy channel estimation may be provided. The capacity of DMRS port configuration may be increased by increasing the length of a cover code in time or frequency. However, the accuracy of estimation may be reduced due to assumption of no or very little change of channel over duration of the cover code. The accuracy of channel estimation may be enhanced by considering a sliding window over several DMRS transmissions. FIG. 13 illustrates operation of sliding windows for enhancing channel estimation, where each OCC group, indicated by dotted ovals, may have two estimates resulting from a first estimate and a second estimate window rather than one estimate. The overall estimate may be enhanced by further processing such as, for example, averaging of the available two estimates. The step for the sliding window may be one or more REs.

In an example embodiment employing DMRS mapping using overlapped cover code, where y, C and h represent received DMRS REs, cover-code matrix, and channel per port for a given estimation window, respectively, y=Ch. For the example depicted in FIG. 13, the first and second estimates from the first and second estimation windows may be computed by the following, h1=C1⁻¹y, h2=C2⁻¹y, where C1 and C2 may be cover-code matrices corresponding to the first and second estimation window.

In an example with N estimation windows, a WTRU may estimate N estimates for each port, if, e.g., only if, all cover-code matrices C1, C2, . . . , CN corresponding to the N estimation windows are invertible.

For example, for the mapping shown in FIG. 11, both presented exemplary C matrices support such a feature. If

$$C 1 = C = [ \begin{matrix}1 & - 1 & 0 & 0 & 0 & 0 \\ 1 & 1 & 1 & 1 & 0 & 0 \\ 0 & 0 & 1 & - 1 & 1 & - 1 \\ 1 & 1 & 0 & 0 & 1 & 1 \\ 1 & - 1 & 1 & - 1 & 0 & 0 \\ 0 & 0 & 1 & 1 & 1 & 1\end{matrix} ]$$

then

$$C 2 = [ \begin{matrix}1 & 1 & 0 & 0 & 1 & 1 \\ 1 & - 1 & 1 & - 1 & 0 & 0 \\ 0 & 0 & 1 & 1 & 1 & 1 \\ 1 & - 1 & 0 & 0 & 0 & 0 \\ 1 & 1 & 1 & 1 & 0 & 0 \\ 0 & 0 & 1 & - 1 & 1 & - 1\end{matrix} ] ,$$

where C2⁻¹ evaluated as

$$C {2}^{- 1} = [ \begin{matrix}0.25 & 0 & - 0.25 & 0.5 & 0.25 & 0 \\ 0.25 & 0 & - 0.25 & - 0.5 & 0.25 & 0 \\ - 0.25 & 0.5 & 0.25 & - 0.5 & 0.25 & 0 \\ - 0.25 & - 0.5 & 0.25 & 0.5 & 0.25 & 0 \\ 0.25 & - 0.5 & 0.25 & 0.5 & - 0.25 & 0.5 \\ 0.25 & 0.5 & 0.25 & - 0.5 & - 0.25 & - 0.5\end{matrix} ] .$$

A WTRU may be configured to provide enhanced DMRS indication. A WTRU may be configured by RRC with a DMRS type, e.g., specific DMRS type, configuration such as, for example, type I, type II, etc. A WTRU may receive a dynamic indication to determine the mapping type for the scheduled transmission, e.g., A or B, the assigned DMRS ports, etc.

A WTRU may receive a semi-static configuration for a P port DMRS configuration, e.g., P=24, where the configuration information includes one or more of mapping attributes required for definition of P ports mapping in time, frequency and spatial domain, e.g., information on frequency mapping, time mapping, cover code, etc.

A WTRU may receive a dynamic indication, e.g., a DCI or a MAC CE, from which a WTRU may explicitly or implicitly determine and select a subset of DMRS ports from the P configured DMRS ports for transmission. The dynamic indication may comprise information about one or more of the following: frequency and time mapping of resource elements used for DMRS transmission, e.g., subcarriers, symbols, slots, etc.; an information element, e.g., an index, to determine the cover code used for multiplexing of multiple DMRS ports; an information element, e.g., an index, to determine a transmission beam; an information element, e.g., an index, to determine the associated panel for the DMRS transmission, e.g., identifying a panel for an UL transmission or for a DL reception; an information element, e.g., an index to determine DMRS power offset with respect to the main transmission, e.g., PDSCH, PUSCH, etc.; an indication whether the rate-matching to be performed around the indicated subset of P ports or all the configured P ports; an indication to determine OCC-related information, e.g., length, sequence, etc.; an indication to determine a timing information, e.g., TA, required for an UL transmission; an indication to identify the DMRS sequence initialization seed for the indicated ports; and an indication to determine PTRS association for the dynamically indicated ports. In an example where the dynamic indication comprises an information element to determine a transmission beam, for PDSCH DMRS, multiple TCI information may be configured for the configured P ports. A WTRU may receive an index to select one of the configured TCI for DMRS reception. In another example where the dynamic indication comprises an information element, for PUSCH DMRS transmission, multiple SRIs may be configured for the configured P ports. A WTRU may receive an index to select one of the configured uplink beams for DMRS transmission.

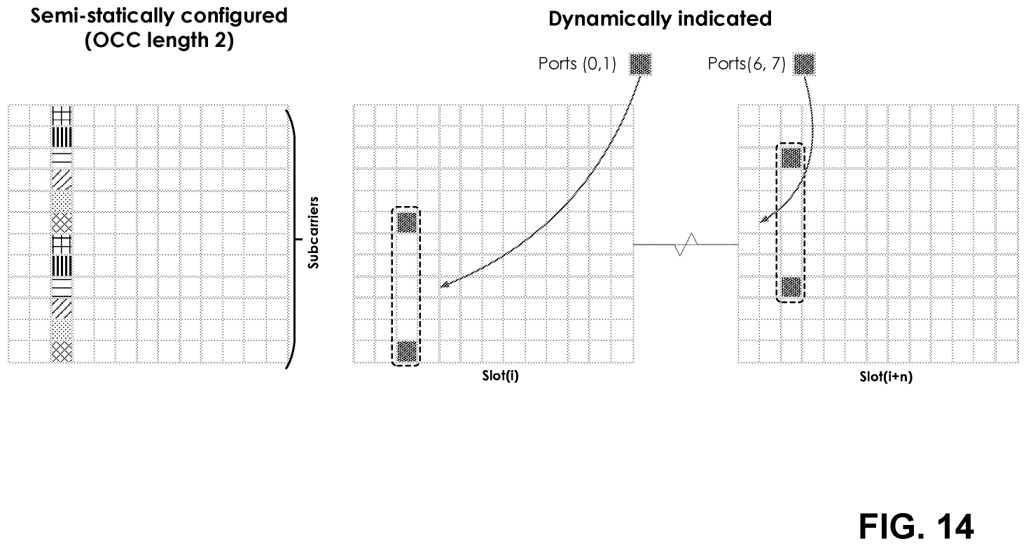

FIG. 14 depicts an example of dynamic DMRS port indication and selection. A single-symbol DMRS mapping comprising 6 groups of 2-port DMRS, each with a cover-code of length 2, may be configured to support 12 DMRS ports. With each dynamic indication which may be, for example, DCI, a WTRU may select a different set of ports for transmission for each transmission.

A WTRU may receive a first configuration by a RRC to support P port DMRS operation, e.g., P=24, where the configuration information includes one or more of mapping attributes required for definition of P ports mapping in time, frequency, and spatial domain, e.g., information on frequency mapping, time mapping, cover code, etc. A WTRU may further receive a DCI including information related to DMRS ports.

For CP-OFDM transmission, up to 5 and 6 bits may be used in a scheduling DCI to indicate DMRS ports for uplink and downlink transmissions respectively where in either case not all the codepoints may be used. A WTRU may determine whether the indicated DMRS ports by the DCI may be based on a legacy or enhanced P-port DMRS configuration using one or more of reserved codepoints/states in the received DCI, e.g., DCI field for antenna port indication.

If a WTRU that may be configured by RRC with the DMRS mapping, e.g., legacy DMRS mapping, (e.g., dmrs-Type=1, maxLength=1 where 4 bits are allocated for the antenna port indication), and an enhanced DMRS configuration, receives a DCI format 1_1, the WTRU may determine whether the legacy or enhanced mapping is indicated by the DMRS antenna port field by checking one or more of the reserve states in the antenna port, e.g., states 12-15.

Once a WTRU determines that the indicated DMRS ports are from the enhanced DMRS configuration, a WTRU may interpret the content of the antenna port indication field in the decoded DCI according to enhanced DMRS configuration mapping.

A WTRU may determine whether the DMRS ports indicated by the DCI may be based on a legacy or enhanced P-port DMRS configuration using one or more of the following: an RRC configuration to semi-statically configure the enhanced DMRS configuration; a MAC CE to activate/deactivate the enhanced DMRS configuration, or alternatively activate the DMRS enhanced mapping based on a counter or for a preconfigured duration; a WTRU capability, for example, when a WTRU declares uplink transmission using 8TX antennas; and an implicit indication based on another operational/configuration parameter or mode, e.g., mobility, multi-user operation mode, cell ID, etc.

A WTRU may be configured to provide enhanced CDM grouping. CDM groups may be associated with antenna ports. A CDM group may be used to multiplex one or more DMRS ports in a code domain, wherein orthogonal cover code may be used to multiplex one or more DMRS ports in the code domain. A CDM group may multiplex up to N DMRS ports. If the total number of DMRS ports (Ntot) may be larger than N (e.g., Ntot>N), more than one CDM group may be used. For example, if Ntot=2N, two CDM groups may be used to multiplex 2N DMRS ports. The time/frequency resources for a CDM group may be mutually exclusive to that for another CDM group.

A set of DMRS ports may be configured, determined, or used for a data transmission/reception (e.g., PDSCH, PUSCH) and one or more PTRS ports may be configured, determined, or used with the set of DMRS ports. The presence/absence and/or pattern of PTRS may be determined based on at least one of scheduling information (e.g., scheduling bandwidth, MCS, and waveform type including OFDM and DFT-s-OFDM).

A WTRU may determine the number of PTRS ports for a data transmission/reception (e.g., PDSCH or PUSCH) based on one or more properties of the set of DMRS ports associated with the data transmission/reception. The set of DMRS ports associated with the data transmission/reception may be the DMRS ports used, determined, or selected for the data transmission/reception for a given the number of determined layers. The one or more properties of the set of DMRS ports may comprise at least one of following: DMRS type (e.g., Type1, Type2); number of CDM groups associated with the set of DMRS ports determine, used, or selected for the data transmission/reception; DMRS density; DMRS pattern; CDM group without data; EPRE ratio between DMRS and PDSCH/PUSCH REs; or antenna coherency level (full/partial coherency, non-coherent). The number of PTRS ports may be the same as the number of CDM groups associated with the set of DMRS ports used for the data transmission/reception.

A PTRS port may be associated with a group of DMRS ports. Therefore, a phase error (e.g., common phase error) measured from the PTRS port may be compensated for the data using DMRS ports in the group associated with the PTRS port. The group of DMRS ports may be determined based on the DMRS ports associated with the same CDM group. For example, in DMRS type1, DMRS ports {1, 2, 3, 4} may be associated with a first CDM group and DMRS ports {5, 6, 7, 8} may be associated with a second CDM group, wherein a first PTRS port may be associated with the DMRS ports in the first CDM group and a second PTRS port may be associated with the DMRS ports in the second CDM group.

A PTRS port may be associated with a DMRS port within the group of DMRS ports for a phase error (e.g., common phase error) estimation and/or channel estimation. For example, a WTRU may perform phase error estimation by using the PTRS and corresponding DMRS associated with the PTRS. In another example, a WTRU may perform channel estimation by using DMRS and corresponding PTRS. The DMRS port in the group of DMRS ports associated with the PTRS port may be determined based on at least one of following: a DMRS port with the lowest DMRS index within the group; and/or a DMRS port with the strongest power within the group, wherein the strongest power may be based on the modulation order (or MCS) determined for the DMRS port.

The group of DMRS ports may be determined based on the DMRS ports associated with the same antenna panel or antenna group. A WTRU may report its capability related to antenna panel and its associated DMRS ports after initial access procedure (e.g., during RRC connection setup), wherein the DMRS ports associated with the same antenna panel may be indicated as antenna group.

The group of DMRS ports may be determined based on antenna coherency (e.g., full/partial coherent, non-coherent) at the WTRU. For example, if a WTRU may have full coherent antennas (or indicated to have full coherent antennas as a capability), the group of DMRS ports may be all DMRS ports that are configured or used. If a WTRU may have partial coherent antennas (or may be indicated to have partial coherent antennas as a capability), the group of DMRS ports may be based on the DMRS ports associated with the CDM group. If a WTRU may have non-coherent antennas (or may be indicated to have non-coherent antennas as a capability), each DMRS port may be determined as a group.

An indication of CDM groups may be provided. A WTRU may indicate a set of configured DMRS ports to be associated with a PTRS port. The configured DMRS ports may belong to the same or different CDM groups. For example, if a WTRU receives a configuration for DRMS Type 1, a subset of the configured DMRS ports may either belong to CDM group 0 or group 1. Also, if a WTRU may be configured with DRMS Type 2, a subset of the DMRS ports may belong either to CDM group 0, 1 or 2. A WTRU may use the CDM group to determine the DMRS port(s) associated with PTRS port(s). The set of configured DMRS ports for PTRS-DMRS association may be from the same CDM group.

If PTRS transmission is configured, a WTRU may receive a configuration indicating the CDM group mapping of the DMRS ports associated with one or more of the PTRS ports for data transmission/reception. This configuration may comprise a list of different CDM group mappings where each mapping may be assigned a codepoint (i.e., bits). A WTRU may receive a DCI which may include a bit field to indicate the codepoint corresponding to each mapping. An option may be to reuse an existing bit field in the DCI to indicate the CDM group mapping. For example, in the DCI for uplink transmission, bits, e.g., up to 5 bits, may be available for DMRS-antenna port indication. Some of the codepoints may be unused and may be used to indicate the different CDM group mapping. A WTRU may determine the CDM group of the DMRS port(s) associated with a PTRS port by checking one of the reserved codepoints in the antenna ports field of the DCI. A WTRU may transmit a PTRS along with a set of DMRS ports wherein the set of DMRS ports may be mapped to the indicated CDM group.

A WTRU antenna layout may be divided into antenna panel or antenna groups wherein each antenna group comprises a subset of the WTRU antennas. Each antenna group may consist of the same or different number of TX antenna. A WTRU may receive configuration that the DMRS port(s) associated with PTRS port for each antenna group may be from same CDM group.

An existing field in the DCI may be used to indicate the CDM group mapping for the DMRS port(s) associated with the PTRS port. For example, a PTRS-DMRS association field in the DCI may be used for CDM group indication where each codepoint is assigned a CDM group (e.g., 0→CDM 0, 1→CDM 1, 2→CDM 2, 3→Reserved). A WTRU may receive a DCI with an indication of CDM group, then transmit PTRS along with one of the DMRS ports from the indicated CDM group. For example, if value 0 may be indicated in the PTRS-DMRS association DCI field, then the DMRS associated with the PTRS port(s) may be mapped to CDM group 0, and a WTRU may transmit a PTRS along with DMRS ports of CDM group 0.

A WTRU may receive a configuration where each antenna group may map to a different CDM group. The configuration may include a list of all possible combinations of CDM group-to-antenna group mapping. A WTRU may receive an indication in a DCI with the CDM group for each antenna group, then the WTRU may transmit PTRS on one of the DMRS ports of indicated CDM group for each antenna group. For example, some reserved codepoints in antenna ports DCI field may be used to indicate the CDM group assignment where each code point contains one of the possible combinations of the CDM group-to-antenna group mapping. In DMRS type 1, with a case of 2 antenna groups, a reserved codepoint may have its input as ‘01’, wherein a rule may be assigned such that the first number indicates that the DMRS ports in the first antenna group may be mapped to CDM group 0, and the second number may indicate that the DMRS ports in the second antenna group may be mapped to CDM group 1.

Enhanced DMRS mapping may be provided. The enhanced DMRS mapping may be associated with MU-MIMO transmission. OCCs may be used to support transmission port multiplexing associated with reference signals. In NR DMRS design, OCC length 2 may be used to multiplex DMRS ports such that OCC pairings may be within a single RB. To support a higher number of DMRS ports, an OCC length 4 may be used. Since with a Type 1 DMRS configuration, there may be 6 DMRS REs per PRB, then if using an OCC length 4, the first DMRS REs may be covered with a first OCC, while the last two remaining DMRS REs may be bundled with the first DMRS REs of the adjacent PRBs to complete the next set of OCC mapping. If a longer length OCC may be used (e.g., length 4), the issue of orphan resource elements (REs) may arise—that is, the remaining unmapped REs if the number of REs for DMRS within a resource block may not be a multiple of the OCC length. For MU-MIMO transmission, the issue of orphan REs may exist if 2 or more WTRUS may be scheduled with two different starting PRBs.

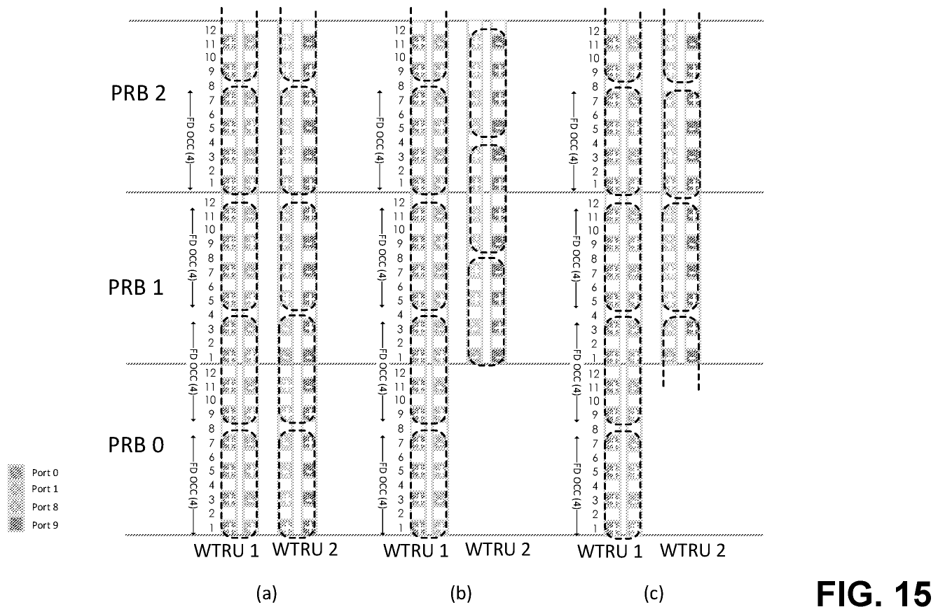

FIG. 15 depicts an example case of MU-MIMO transmission with and without FD shift of OCC mapping. Referring to FIG. 15 at section (a), an exemplary case of MU-MIMO transmission configured with DMRS type 1 with FD-OCC length 4 may be depicted. Two WTRUs, each configured with two (2) DMRS ports, may be scheduled with the same starting PRB for their PDSCH resource mapping. Therefore, the OCC mappings for the co-scheduled WTRU may be aligned (e.g., perfectly aligned) to enable a proper orthogonalization of DMRS ports associated to the two WTRUs.

Referring to FIG. 15 at section (b), another exemplary case of MU-MIMO transmission configured with DMRS type 1 with FD-OCC length 4 may be depicted. Two WTRUs, each configured with two (2) DMRS ports, may be scheduled with a different starting PRB for their PDSCH resource mapping. As demonstrated in FIG. 15 at section (b), the starting PRB of the scheduled transmission for WTRU 1 is at PRB 0, while the starting PRB of the scheduled transmission for WTRU 2 is at PRB 1. Since PDSCH allocations may not be aligned due to different starting PRBs, the OCCs may be mismatched and may not be used for orthogonalization of DMRS ports.

Referring to FIG. 15 at section (c), an exemplary solution may be depicted for the case of MU-MIMO transmission configured with DMRS type 1 with FD-OCC length 4 when the starting PRB of the scheduled PDSCH transmissions may not be the same or not separated by an even number of PRBs. For proper orthogonalization and separation of the DMRS ports, the starting RE of the OCC of one of the WTRUs may be shifted by half the length of the OCC. As demonstrated in FIG. 15 at section (c), while the starting PRB of the scheduled transmission for WTRU 2 may be at PRB 1, the start of the full OCC in PRB 1 may be at the third DMRS RE. As a result of this shift, the remaining sets of OCCs may be aligned, e.g., perfectly aligned.

If a WTRU may be configured with an FD-OCC length that results in some orphan REs, a WTRU may use a FD shifted version of the OCC mapping to align its mapping with another scheduled transmission. A WTRU may determine whether to perform, e.g., the usefulness or necessity of performing, a FD shift based on one or more of several implementations. In a first implementation for determining whether to perform a FD shift, a WTRU may receive a dynamic indication to shift the OCC mapping for a scheduled transmission. The indication may be received as part of the scheduling DCI or indicated separately by MAC-CE if needed.

In a second implementation for determining whether to perform a FD shift, a WTRU may determine the FD shift of the OCC from the index of a reference PRB of the scheduled PDSCH transmission, e.g., the index of the first PRB. A WTRU may determine an FD shift of the OCC if the index of the first PRB of the scheduled PDSCH transmission is an odd number.

In a third implementation for determining the usefulness, e.g., necessity, of a FD shift, a WTRU may determine the FD shift of the OCC from the set of indicated antenna ports. A first group of antenna ports may be associated with a first OCC mapping, and a second group of antenna ports may be associated with a second OCC mapping. It will be appreciated that while the text refers to performing alignment by shifting of OCC mappings, the disclosed concepts for performing alignment to prevent orphan resources may likewise apply to, for example, CDM groups.

Enhanced PTRS configuration may be provided. PTRS configuration for an M-TX WTRU may be provided. For an uplink transmission, a WTRU may partition an M-TX antenna set to K antenna groups comprising of N TX antennas per antenna group, where N≤M. It may be further assumed that the antennas within each antenna group are coherent. For the brevity of presentation of the main idea, it is assumed that each antenna group has the same number of TX antennas, however the same presented implementations below may be applied for the cases where antenna groups have a different number of TX antennas. A WTRU with K antenna group may be configured with one or more DMRS ports per antenna group. The indicated DMRS ports for each antenna group may be mapped to the same CDM group.

A WTRU may be configured with more than one PTRS reference signals to assist phase tracking at a gNB. A PTRS-DMRS association may be realized, for example, where a WTRU may indicate through an implicit or an explicit manner the number of the antenna groups, K. Upon receipt of the indication, a WTRU may be indicated one or more PTRS ports. A WTRU may be indicated K or less PTRS ports according to an indicated K antenna group.

A PTRS-DMRS association may be realized, for example, where a WTRU may receive an explicit or an implicit indication about the preferred antenna group for PTRS transmission, for example, the antenna group with the strongest uplink transmission. The indication may be in the form of an information element indicated in a DCI or MAC CE, or alternatively by an SRI. Then, a WTRU may transmit PTRS using the indicated antenna group.

A PTRS-DMRS association may be realized, for example, within an antenna group, wherein the PTRS port may be associated with the lowest indexed DMRS port associated with the antenna group.

A PTRS-DMRS association may be realized, for example, wherein a WTRU with K antenna groups may cycle PTRS transmission over the K antenna group. The length of a cycle may be fixed or indicated by a semi-static or dynamic signaling. A WTRU may be indicated to cycle the PTRS port based on one or more of the following: per transmission grant, e.g., for a first transmission, antenna group X, and for a second transmission, antenna group Y may be used; as a function of slot number, e.g., odd/even, every X slots; the cycling may follow a pseudo random sequence, where it may be initialized by a seed. The seed may be explicitly indicated to a WTRU or determined implicitly from other configuration parameters. The RB location for PTRS mapping may also change with each cycle of PTRS transmission from an antenna group.

An indication of PTRS-DMRS association may be provided. In NR uplink, a WTRU may determine the PT-RS port association to the DM-RS ports as a function of an indication received in a DCI, and as a function of the WTRU capability. Ports, e.g., up to two PT-RS ports may be indicated. For a fully coherent WTRU, a single PT-RS port may be used whereas a partially or non-coherent WTRU may use two PT-RS ports. In non-codebook case, a WTRU may receive a DCI with an SRI indicating an SRS resource. The WTRU may receive an SRS configuration which indicates the associated PT-RS ports per SRS resource (ptrs-PortIndex in SRS-Config). In codebook case, a WTRU may receive a DCI with the 2-bit field PTRS-DMRS association. When 1 PTRS port is used, it may indicate one of four antenna ports, and DMRS port mapped to the indicated antenna port may be associated to a PTRS port. If 2 PTRS ports may be used, MSB and LSB of DCI field may indicate one of the antenna ports for PTRS.

However, if a larger number of antenna ports may be considered, there may be no rule to map the PT-RS ports to DMRS.

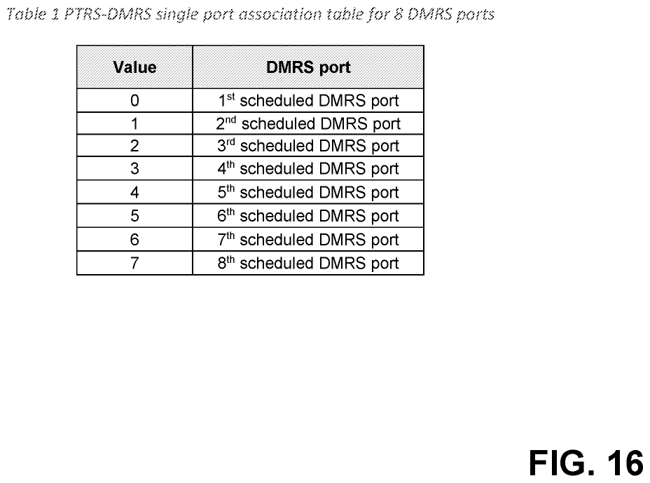

MAC-CE based PTRS-DMRS port association may be provided. One example implementation may be to increase the bitfield in the DCI, and dynamically indicate all, e.g., all new, possible combinations arising from the increase in DMRS ports. FIG. 16 depicts example Table 1 showing PTRS-DMRS single port association for 8 DMRS ports. In Table 1, 3 bits may be used to define an association for up to 8 DMRS ports when a single PTRS port is used. The WTRU may receive the RRC configured table, and the DCI may indicate one of the values in the table. Different tables indicating PTRS-DRMS port associations may be configured depending upon circumstances, e.g., configured per serving cell, and use of the tables may be conditioned on the presence of one or more additional configurations and/or WTRU capabilities (e.g., 8TX).

A WTRU may determine the PTRS-DMRS port association as a function of a MAC-CE which may indicate one of the values from a table such as, for example, Table 1 depicted in FIG. 16. The MAC-CE may contain an explicit indication of the association between the indicated DMRS and PT-RS ports. A WTRU may receive a MAC-CE with an indication of one out of 8 ports from the DMRS index. The example table depicted in FIG. 16 provides an exemplary mapping of one value to a DMRS port association where the value represents the numerical equivalent to a bitstring (e.g., 3 bits). The MAC CE may additionally contain fields which may indicate one or more serving cells and/or cell IDs for which the association applies. The MAC-CE may contain the 3-bit indication field if a single PTRS port may be used, and the WTRU may use the 3-bit indication to determine on which DMRS port to transmit the PTRS. A single PTRS port may be associated with the DMRS. The WTRU may use the PTRS-DMRS port association until it receives another MAC-CE that may activate a different association. Upon reception of the MAC CE by a MAC entity, the WTRU may forward the contents of the MAC CE to lower layers for processing.

A MAC CE may indicate an association is deactivated. Upon reception of a deactivation MAC CE, the WTRU may no longer consider that association as valid and may revert to a default and/or alternate association. Whether a MAC CE activates and/or deactivates an association may be indicated explicitly via a field which may be identified by, for example, a flag bit.

A WTRU may receive a MAC-CE with an 8 port DMRS index and more than one PTRS ports indices. A PTRS port may be explicitly associated with the DMRS ports via a mapping such as depicted in Table 1 depicted in FIG. 16. A WTRU may receive an additional rule to determine one DMRS when multiple DMRS ports are associated with the same PTRS port. The rule may be based on, for example, the lowest scheduled DMRS port amongst all ports associated with the same DMRS port.

In an example, the MAC-CE may contain an indication to map DMRS ports 1-4 to the first PTRS port, and DMRS ports 5-8 to the second PTRS port. After receiving the MAC-CE, a WTRU may receive a DCI scheduling a PUSCH with 8TX. Based on the received MAC-CE activation, the WTRU may transmit two port PTRS with the UL DMRS transmitted on the PUSCH. The WTRU may determine to transmit two PTRS where the first PTRS is associated with the lowest DMRS port in the first group (scheduled port 1), and the second PTRS port may be associated with the lowest DMRS port in the second group (scheduled port 5).

Upon reception of a DCI indication and/or MAC CE activation/deactivation, a WTRU may assume that the configuration may be valid for a certain period and/or number of resources. Upon reception of a DCI and/or MAC CE activation/deactivation, a WTRU may start a prohibit timer, wherein the WTRU may not expect to receive an update value. A WTRU may, for example, discard any subsequent DCI values and/or MAC CE activation/deactivation received during this time.

In the absence of a DCI indication and/or MAC CE activation, a WTRU may select a default value to apply. The default value may be based on configuration information or may alternatively be indicated via, for example, system information. Once a WTRU may have received a DCI-indicated value and/or MAC CE activated association, the WTRU may apply this value, for example, for one or more of the following durations: for the transmission and/or reception scheduled by the DCI; for a specific duration after DCI reception and/or MAC CE activation; or until a subsequent DCI and/or MAC CE indicates a value and/or association which is different from the previously indicated value. In the instance the applied duration is for a specific duration after DCI reception and/or MAC CE activation, the WTRU may assume the value is valid for the next X seconds and/or Y transmissions/receptions. Upon reception of a DCI or MAC CE, the WTRU may start a timer or counter. Upon expiry of the counter, the WTRU may, for example, revert back to a default value and/or expect and/or request an updated value.

A WTRU may request a PTRS-DMRS port association from the network. The request may be via MAC CE, UCI, or via RRC signaling, and may be specific to a cell and/or PTRS port. A WTRU may send such a request, for example, upon one or more of the following events: upon expiry of the validity of an association (e.g., expiry of a timer and/or counter); upon RRC reconfiguration (e.g., upon reconfiguration of a PTRS-DMRS port association table); upon beam failure detection (BFD) and/or beam failure recovery (BFR); upon radio link failure (RLF); upon RRC state transition (e.g., upon transition to and/or from RRC_IDLE, RRC_INACTIVE, RRC_CONNECTED) state).

Upon mobility to a new cell, a WTRU may be provided with a PTRS-DMRS port association as part of RRC reconfiguration. The WTRU may alternatively receive an indication (e.g., within a handover command) that the PTRS-DMRS association is the same and/or different from the current serving cell.

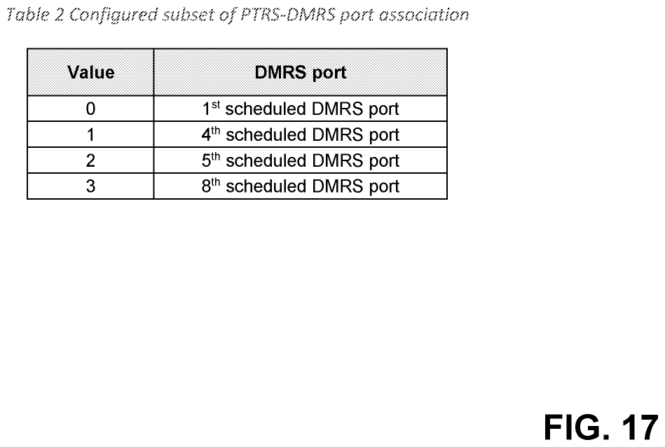

PTRS-DMRS port association may be based on DCI and MAC-CE. A MAC-CE may activate or indicate the PTRS-DMRS port associations from a subset of all possible associations. The WTRU may dynamically select one of the indicated associations from the MAC-CE as a function of a field in a DCI. A WTRU may receive a MAC-CE field with two-bit fields configured as indicated, for example, in Table 2 depicted in FIG. 17. Table 2 indicates a configured subset of PTRS-DMRS port association. Table 2 may comprise a subset of the fields comprised in Table 1 as depicted in FIG. 16. After receiving the MAC-CE, a WTRU may receive a DCI scheduling a PUSCH, and the DCI may reuse the existing PTRS-DMRS association field in the DCI to signal one of the PTRS-DMRS port association fields from the subset indicated in Table 2 depicted in FIG. 17. For example, if the WTRU may receive a PTRS-DMRS association value of 2, a WTRU may determine, based on the information in Table 2 depicted in FIG. 17, to transmit a PTRS in the same port as the 5th scheduled DMRS port.

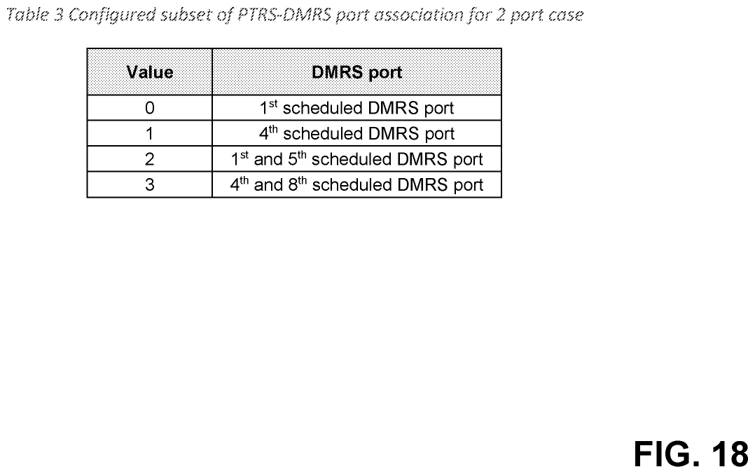

If more than one PTRS port may be used, sets of DMRS ports may be associated with PTRS ports according to a row index of a table such as, for example, Table 3 depicted in FIG. 18. Table 3 indicates a configured subset of PTRS-DMRS port association for 2 port cases. If a WTRU receives a value of 2, a WTRU may determine, based on the information in Table 3, that the 1st and 5th scheduled DMRS port may be associated with the first and second PTRS ports, respectively.

Dynamic PTRS field reinterpretation may be performed based on actual numbers of layers. A WTRU may determine that one or more codepoints of a PTRS field (e.g., the ‘PTRS-DMRS port association’ field) in DCI may be reinterpreted based on an actual number of layers which may be indicated along with the DCI (or in relation with the DCI, or by a second field of the DCI (e.g., ‘Precoding information and number of layers’ field) indicating an actual number of scheduled layers).

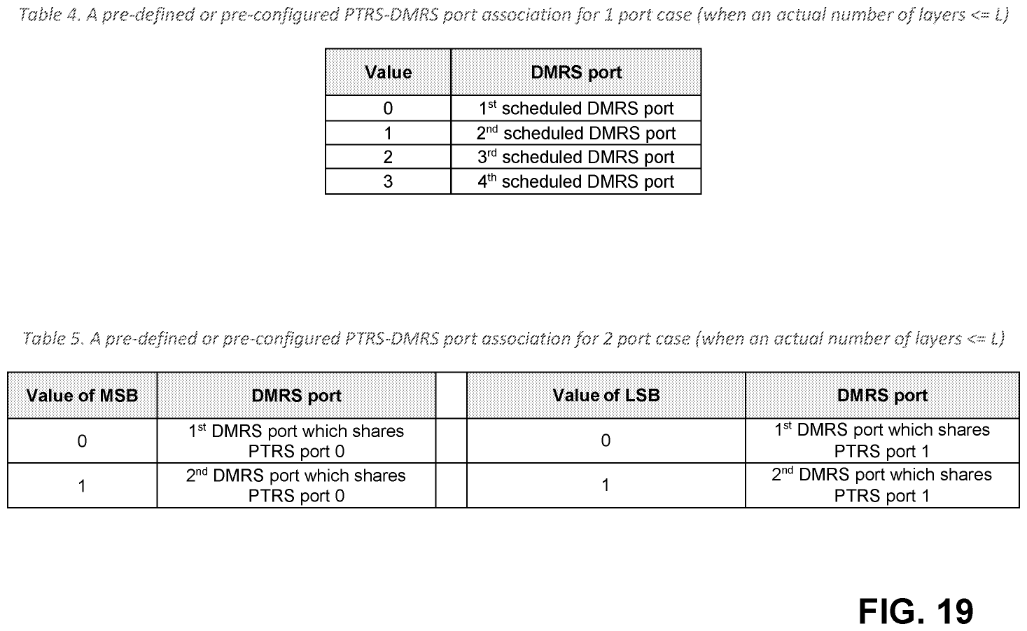

The WTRU may apply a pre-defined or a pre-configured PTRS field (e.g., ‘PTRS-DMRS port association’ field) in response to determining that the actual number of layers is less than or equal to L. L may be 2 for a 4-Tx UL mode of operation. L may be 4 for an 8-Tx UL mode of operation. The pre-defined or pre-configured PTRS field may be based on Table 4 (for 1 PTRS-port case) and Table 5 (for 2 PTRS-port case) as depicted in FIG. 19. Table 4 indicates example pre-defined or pre-configured PTRS-DMRS port association for 1 port case (if an actual number of layers<=L). Table 5 indicates example pre-defined or pre-configured PTRS-DMRS port association for 2 port case (if an actual number of layers<=L).

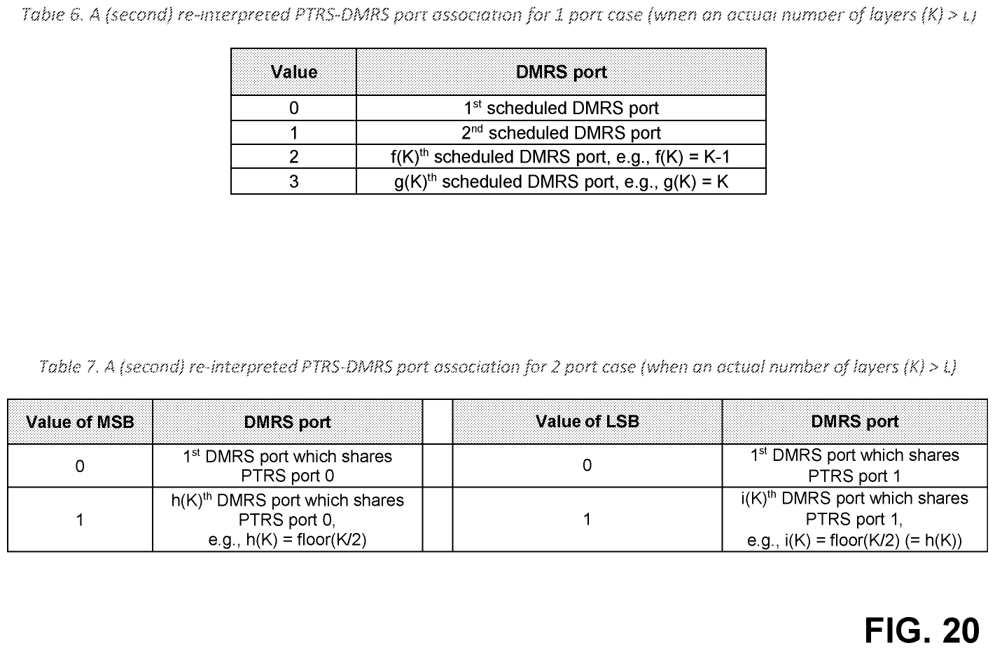

The WTRU may apply a pre-configured/indicated (e.g., via RRC and/or MAC-CE) second re-interpreted PTRS field (e.g., ‘PTRS-DMRS port association’ field) in response to determining that the actual number of layers (e.g., denoted by K) is greater than L. L may be 2 for a 4-Tx UL mode of operation. L may be 4 for an 8-Tx UL mode of operation. The second re-interpreted PTRS field may be based on the following Table 6 (for 1 PTRS-port case) and Table 7 (for 2 PTRS-port case) which are depicted in FIG. 20. Table 6 indicates an example (second) re-interpreted PTRS-DMRS port association for 1 port case (when an actual number of layers (K)>L). Table 7 indicates an example (second) re-interpreted PTRS-DMRS port association for 2 port case (when an actual number of layers (K)>L).

In Table 6, a value (or codepoint) of the second re-interpreted PTRS field (for 1 port case) may indicate a f(K)th scheduled DMRS port or g(K)th scheduled DMRS port, where the f(K) or g(K) may be a pre-configured/indicated function with respect to K (as an actual number of layers). f(K) may be pre-configured or indicated to be f(K)=K−1, and g(K) may be pre-configured or indicated to be g(K)=K. If the WTRU may determine the actual (scheduled) number of layers K may be 5 (>L), the WTRU may interpret the value (or codepoint) of 2 may be, based on f(5)=5−1=4, to be “4th scheduled DMRS port,” and the value (or codepoint) of 3 may be, based on f(5)=5, “5th scheduled DMRS port.” If the WTRU may determine the actual (scheduled) number of layers K may be 7 (>L), the WTRU may interpret the value (or codepoint) of 2 may be, based on f(7)=7−1=6, “6th scheduled DMRS port,” and the value (or codepoint) of 3 may be, based on f(7)=7, “7th scheduled DMRS port.”

The WTRU may receive different function(s) of f(K) and g(K) (e.g., via pre-configuration or indicated), which may provide benefits in terms of flexibility in allocating different PTRS-DMRS mapping pattern(s) and improving performance based on the flexible association between PTRS and DMRS ports.

In Table 7, a value (or codepoint) of the second re-interpreted PTRS field (for 2 port case) may indicate a h(K)th DMRS port which shares PTRS port 0 or i(K)th DMRS port which shares PTRS port 1, where the h(K) or i(K) is a pre-configured/indicated function with respect to K (as an actual number of layers). The WTRU may determine which DMRS port(s) are shared with PTRS port 0 or 1, based on a pre-configured higher-layer message (or parameter). For example, an RRC (and/or MAC-CE) parameter may configure/indicate such linkage between DMRS port(s) and a PTRS port to be shared with each other. h(K) may be pre-configured or indicated to be h(K)=floor(K/2), and i(K) may be pre-configured or indicated to be i(K)=floor(K/2). The function floor(A) may imply to point to an integer number that may or may not exceed an input value of A for the function. If the WTRU may determine the actual (scheduled) number of layers K is 5 (>L), the WTRU may interpret the value of MSB of 1 may be, based on h(5)=floor(5/2)=2, “2nd DMRS port which shares PTRS port 0,” and the value of LSB of 1 may be, based on i(5)=floor(5/2), “2nd DMRS port which shares PTRS port 1.” If the WTRU may determine the actual (scheduled) number of layers K is 7 (>L), the WTRU may interpret the value of MSB of 1 may be, based on h(7)=floor(7/2)=3, “3rd DMRS port which may share PTRS port 0,” and the value of LSB of 1 may be, based on i(7)=floor(7/2), “3rd DMRS port which may share PTRS port 1.”

The WTRU may receive different function(s) of h(K) and i(K) as being pre-configured or indicated, which may provide benefits in terms of flexibility in allocating different PTRS-DMRS mapping pattern(s) and improving performance based on the flexible association between PTRS and DMRS ports.

The parameter of L (as the layer-domain threshold) may be configured or indicated to be more than one, meaning L1, L2, and so on, may be configured or indicated. L1 may be set to 4 and L2 may be set to 6, e.g., for an 8-Tx UL mode of operation, where the WTRU may be configured or indicated with additional (third) re-interpreted PTRS-DMRS port association table (or field). The second re-interpreted PTRS-DMRS port association table (or field) may be applicable for L1<K<=L2, and a third re-interpreted PTRS-DMRS port association table (or field) may be applicable for K>L2, and so forth.

The WTRU may perform reporting (transmitting) a WTRU-capability parameter/information related to (e.g., based on) at least one of L, L1, L2, f(K), g(K), h(K), and i(K), etc. Based on receiving such WTRU-capability reporting from the WTRU, a gNB may configure or indicate at least one of L, L1, L2, f(K), g(K), h(K), and i(K), etc. to the WTRU for the re-interpretation behavior(s) for PTRS-DMRS port association and determining PTRS port(s) to be mapped to which DMRS port(s).

A WTRU may be configured to associate groups of DMRS ports with code-division-multiplexed (CDM) groups and to map the groups of DMRS ports associated with the CDM groups to groups of antenna groups. A WTRU may be configured to determine to map PTRS ports to DMRS ports based on MCS values associated with the DMRS ports.

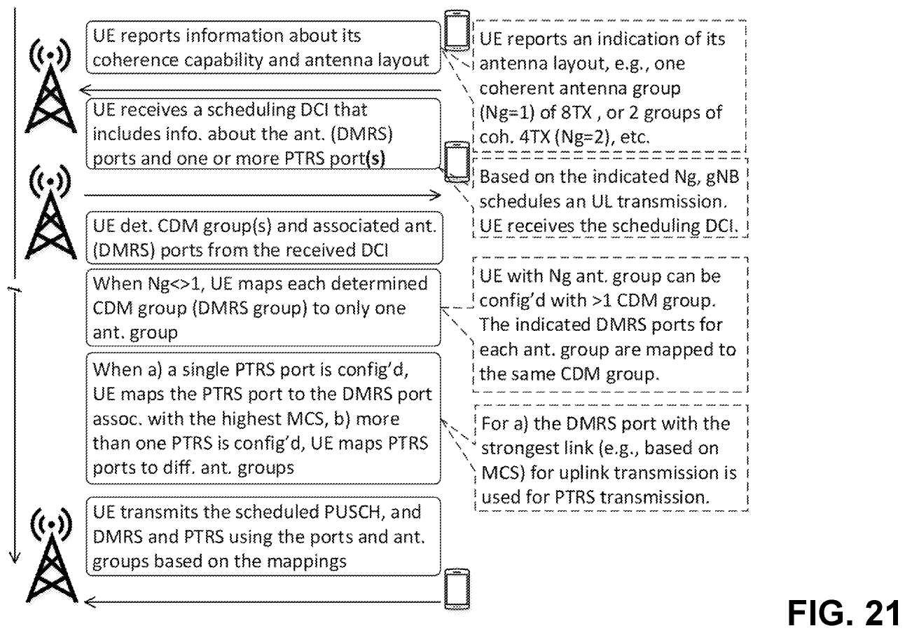

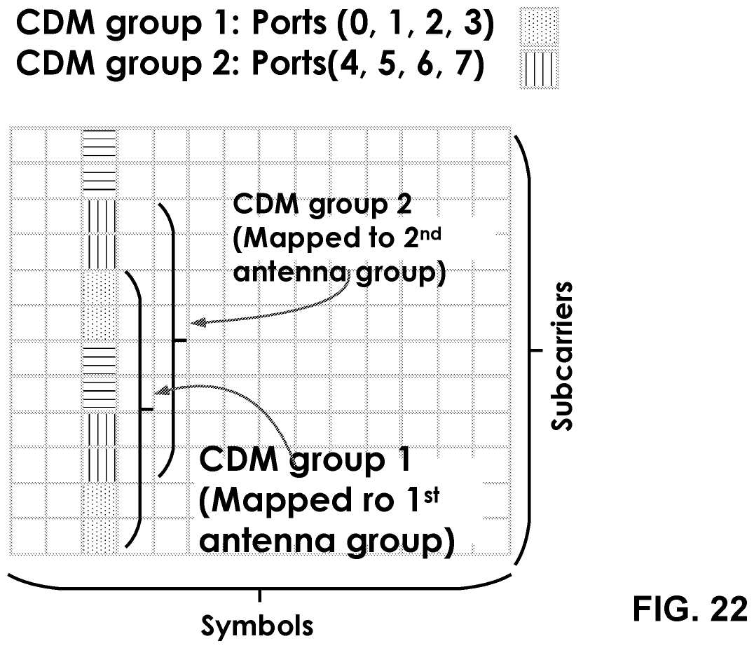

FIG. 21 depicts example implementations for antenna group and PTRS-DMRS determination where each CDM/DMRS group may be mapped to a different antenna group. FIG. 22 depicts example CDM/DMRS mapping to an antenna group for an 8-layer transmission. In the example depicted in FIG. 22, CDM to antenna group mapping may be depicted for an 8-layer transmission where each CDM group may have a length of 4.

Referring to the example implementation depicted in FIG. 21, a WTRU, which may be referenced as a UE in FIG. 21, may report, e.g., implicitly or explicitly report (e.g., indicate), information about its coherence capability and antenna layout. The indicated information may comprise, for example, a number of antenna groups, Ng. As shown, the information may indicate, for example, one coherent antenna group (Ng=1) of 8 transmitters, or two groups of 4 coherent transmitters (Ng=2). Based on the indicated antenna grouping, a network device such as, for example, a base station (e.g., gNB used for example herein), may schedule an uplink transmission and send scheduling DCI, e.g., information scheduling a PUSCH transmission and information about DMRS antenna ports and one or more PTRS ports, to the WTRU.

The WTRU may receive DCI that schedules a transmission, e.g., a PUSCH transmission, and/or that may include association information associating DMRS ports with CDM groups. The DCI may comprise information about the DMRS antenna ports and one or more PTRS ports.

The WTRU may relate or associate a first set of DMRS ports with a first CDM group and a second set of DMRS ports with a second CDM group based on the association information indicated in the DCI.

The WTRU may map the first set of DMRS ports associated with the first CDM group to a first antenna group and may map the second set of DMRS ports associated with the second CDM group to a second antenna group. If the WTRU comprises one coherent antenna group, e.g., Ng=1, the WTRU may map each determined CDM group (and the associated DMRS group) to the one antenna group. A WTRU configured with more than one CDM group may map DMRS ports for each antenna group to the same CDM group.

The WTRU may transmit the scheduled transmission which may be, for example, a PUSCH transmission. The transmission may comprise at least a first DMRS that may be transmitted using the first set of DMRS ports and the first antenna group and at least a second DMRS that may be transmitted using the second set of DMRS ports and the second antenna group.

The received DCI may indicate one or more PTRS ports. If one PTRS port is configured or indicated, the WTRU may map the one PTRS port to a first DMRS port in the first or second set of DMRS ports. The first DMRS port may be determined based on a MCS associated with the first DMRS port and may transmit a PTRS using the one PTRS port based on the mapping to the first DMRS port. The DMRS port with the strongest link for uplink transmission, which may be determined based on the associated MCS, e.g., highest MCS value of MCS values associated with first or second set of MRS ports, may be used for the PTRS transmission.

If more than one PTRS port is configured or indicated, the WTRU may map a first PTRS port to a first DMRS port that may be mapped to the first antenna group and may map a second PTRS port to a second DMRS port that may be mapped to the second antenna group. The WTRU may transmit, e.g., with the PUSCH transmission and DMRS, at least a first PTRS using the first PTRS port based on the mapping to the first DMRS port and may transmit at least a second PTRS using the second PTRS port based on the mapping to the second DMRS port.

Although features and elements described herein are described in particular combinations, each feature or element may be used alone without the other features and elements of the preferred embodiments, or in various combinations with or without other features and elements.

The description herein may be provided for exemplary purposes and does not limit in any way the applicability of the described systems, methods, and instrumentalities to other wireless technologies and/or to wireless technology using different principles, when applicable. The term network in this disclosure may refer to one or more gNBs which in turn may be associated with one or more Transmission/Reception Points (TRPs) or any other node in the radio access network.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-33. (canceled)

34. A wireless transmit and receive unit (WTRU) comprising:
a processor configured to:
receive downlink control information (DCI), the DCI comprising information that schedules a transmission and associates demodulation reference signal (DMRS) ports with code division multiplexing (CDM) groups;
associate a first one or more DMRS ports with a first CDM group based on the DCI;
associate a second one or more DMRS ports with a second CDM group based on the DCI;
map the first one or more DMRS ports associated with the first CDM group to a first antenna group comprising coherent antennas;
map the second one or more DMRS ports associated with the second CDM group to a second antenna group comprising coherent antennas; and
send the transmission, the transmission comprising at least a first DMRS sent using the first one or more DMRS ports and the first antenna group and at least a second DMRS sent using the second one or more DMRS ports and the second antenna group.

35. The WTRU of claim 34, wherein the processor is further configured to:
send information associated with at least one of coherence capability or antenna layout.

36. The WTRU of claim 35, wherein the information associated with the at least one of coherence capability or antenna layout comprises information identifying one or more coherent antenna groups.

37. The WTRU of claim 36, wherein the information identifying one or more coherent antenna groups comprises information identifying a number of antenna groups.

38. The WTRU of claim 36, wherein the information that schedules the transmission and associates DMRS ports with CDM groups is based on the information identifying one or more coherent antenna groups.

39. The WTRU of claim 34, wherein the processor configured to receive DCI is configured to receive the DCI from a base station.

40. The WTRU of claim 34,
wherein the processor is further configured to:
determine a first DMRS port from the first one or more DMRS ports or the second one or more DMRS ports based on a modulation and coding scheme (MCS) value; and
associate a first phase tracking radio signal (PTRS) port with the first DMRS port; and
wherein the transmission further comprises a PTRS sent using the first PTRS port.

41. The WTRU of claim 40, wherein the processor configured to determine the first DMRS port based on the MCS value is further configured to determine the first DMRS port based on the MCS value being a highest MCS value associated with the first one or more DMRS ports or the second one or more DMRS ports.

42. The WTRU of claim 40, wherein the DCI comprises information that indicates the first PTRS port.

43. The WTRU of claim 36, wherein the processor is further configured to:
associate a first PTRS port with a first DMRS port mapped to the first antenna group; and
associate a second PTRS port with a second DMRS port mapped to the second antenna group; and
wherein the transmission further comprises a first PTRS sent using the first PTRS port and a second PTRS sent using the second PTRS port.

44. The WTRU of claim 43, wherein the DCI comprises information that indicates a plurality of PTRS ports.

45. The WTRU of claim 34, wherein the transmission further comprises a physical uplink shared channel (PUSCH) transmission.

46. A method of port mapping, comprising:
receiving downlink control information (DCI), the DCI comprising information that schedules a transmission and associates demodulation reference signal (DMRS) ports with code division multiplexing (CDM) groups;
associating a first one or more DMRS ports with a first CDM group based on the DCI;
associating a second one or more DMRS ports with a second CDM group based on the DCI;
mapping the first one or more DMRS ports associated with the first CDM group to a first antenna group comprising coherent antennas;
mapping the second one or more DMRS ports associated with the second CDM group to a second antenna group comprising coherent antennas; and
send the transmission, the transmission comprising at least a first DMRS sent using the first one or more DMRS ports and the first antenna group and at least a second DMRS sent using the second one or more DMRS ports and the second antenna group.

47. The method of claim 46, further comprising:
sending information associated with at least one of coherence capability or antenna layout.

48. The method of claim 47, wherein the information associated with the at least one of coherence capability or antenna layout comprises information identifying one or more coherent antenna groups.

49. The method of claim 48, wherein the information identifying one or more coherent antenna groups comprises information identifying a number of antenna groups.

50. The method of claim 48, wherein the information that schedules the transmission and associates DMRS ports with CDM groups is based on the information identifying one or more coherent antenna groups.

51. The method of claim 46, wherein receiving DCI comprises receiving the DCI from a base station.

52. The method of claim 46, further comprising:
determining a first DMRS port from the first one or more DMRS ports or the second one or more DMRS ports based on a modulation and coding scheme (MCS) value; and
associating a first phase tracking radio signal (PTRS) port with the first DMRS port; and
wherein the transmission further comprises a PTRS sent using the first PTRS port.

53. The method of claim 52, wherein determining the first DMRS port based on the MCS value comprises determining the first DMRS port based on the MCS value being a highest MCS value associated with the first one or more DMRS ports or the second one or more DMRS ports.
